(19) United States
(12) Patent Application Publication
(10) Pub. No.: US 2012/0153138 A1
(43) Pub. Date: Jun. 21, 2012

(54) METHODS FOR DETECTING SUBSTANCES IN BIOLOGICAL SAMPLES

(75) Inventors: Hollis Horton McCurdy, Conyers, GA (US); Elizabeth Marie Brunelli, Hoschton, GA (US); Beth Ann Hoover, Roswell, GA (US)

(73) Assignee: eLab Consulting Services, Inc.

(21) Appl. No.: 12/971,750

(22) Filed: Dec. 17, 2010

(51) Int. Cl. H01J 49/26

(52) U.S. Cl. 250/282

(57) ABSTRACT

Methods for simultaneously detecting multiple drug classes in a biological sample are described herein. In one embodiment, the biological sample is taken from an animal, such as a human. Suitable classes of drugs include drugs prone to abuse and prescription medications. In one embodiment, the biological sample is enzymatically hydrolyzed to liberate free drug in the sample. Once the biological sample has been prepared, the sample is extracted using solid-phase extraction (SPE). Following solid phase extraction (SPE), the resulting eluate containing the compounds to be detected is diluted and injected into a liquid chromatograph coupled to a triple quadrupole mass spectrometer. Multiple classes of drugs can be analyzed simultaneously in less than about 13 minutes, preferably less than about 11 minutes, more preferably less than about 10 minutes, more preferably less than about 9 minutes, most preferably less than about 8 minutes.

### CROSS REFERENCE TO RELATED APPLICATIONS

### Field of the Invention

This invention is generally in the field of analytical techniques for the simultaneous detection of multiple substances, particularly prescription drugs and/or illicit drugs, in a biological sample, such as urine, blood, saliva, or tissue.

### BACKGROUND OF THE INVENTION

Demands are continually being placed on analytical laboratories—including toxicology—to analyze more samples in a shorter amount of time without compromising data quality.

In the past, analytical toxicology has typically used immunoassays and gas chromatography interfaced to mass spectrometry (GC-MS) to analyze samples. Immunoassay techniques are quick and relatively simple, but have several limitations: 1) immunoassay is only applicable to a small number of therapeutic or illicit drugs; 2) immunoassay lacks specificity for some tests; and 3) immunoassay is difficult to quickly accommodate detection of new drugs.

GC-MS has been frequently used in the past to analyze samples. However, polar and semi-volatile compounds are difficult to analyze using this technique and sample preparation can be time consuming and expensive, often requiring several extraction steps, consumables and derivatization.

Liquid chromatography interfaced to (tandem) mass spectrometry (LC-MS or LC-MSMS) has evolved from a research tool to a routine analytical instrument in several application fields due to ease of use, and the time required to complete the analysis. Adaptation by analytical toxicology laboratories, however, has been slow because of increased instrument cost and additional training/application requirements. Typically, confirmatory drug analyses are grouped and extracted by the individual drug class (e.g., opiates and benzodiazepines) that require several hours to one day of analyst and instrument time per class. Analysis of a single sample that includes multiple batch class extractions may take several days to complete. Personnel and instrument time is increased by a factor equal to the number of extractions required.

Thus, there exists a need for an analytical technique which can simultaneously detect multiple classes of drugs in a short period of time.

Therefore, it is an object of the invention to provide an analytical technique for simultaneously detecting multiple classes of drugs in a short period of time.

### SUMMARY OF THE INVENTION

Methods for simultaneously detecting multiple drug classes in a biological sample are described herein. In one embodiment, the biological sample is taken from an animal. In a preferred embodiment, the animal is a mammal. Exemplary mammals include humans and livestock, such as horses and cattle. In a particularly embodiment, the mammal is a human.

Suitable classes of drugs include drugs that are prone to abuse and prescription medications. Exemplary drugs prone to abuse include marijuana; opioid analgesics, such as oxycodone, hydrocodone, and morphine; cocaine, and stimulants, such as methamphetamine. Exemplary prescription medications include, but are not limited to, medications used to treat mental illness, such as tricylic antidepressants.

In one embodiment, the biological sample is enzymatically hydrolyzed to liberate free drug in the sample. In a particular embodiment, the enzyme is a glucuronidase, such as from E. coli. Glucuronidase-catalyzed hydrolysis is generally required for any sample where glucuronidase metabolites are present. For oral fluid samples, enzymatic hydrolysis is not required.

Once the biological sample has been prepared, the sample is extracted using solid-phase extraction (SPE). Solid-phase extraction (SPE) is a separation process by which compounds that are dissolved or suspended in a liquid are separated from other compounds in the mixture according to their physical and chemical properties. SPE can be used to concentrate and/or purify samples for analysis. Solid phase extraction can be used to isolate analytes of interest from a wide variety of matrices, including urine, blood, saliva, and animal tissue.

Following solid phase extraction (SPE), the resulting eluate containing the compounds to be detected is diluted and injected into a liquid chromatograph coupled to a triple quadrupole mass spectrometer. Four calibrators, referred to as calibrators 1-4, are analyzed to generate a standard calibration curve. These calibrators are spiked standards, generally prepared in house, which are used to generate the standard calibration curve for the particular drug or metabolite to be analyzed. Each sample is read against the standard curve in order to obtain a value. The use of four calibrators allows for the exclusion of one data point, if necessary, while maintaining a valid calibration curve.

Calibrator 1:10 is a dilution of the lowest concentration calibrator 1-4 and can be used for the detection of low concentrations of a drug or metabolite thereof by validating the standard calibration curve at low concentrations.

At least one control for each drug being analyzed is also employed in the analytical scheme. These controls are commercially available from outside vendors or can be prepared in-house and are used to confirm the standard calibration curve. The results are measured against the standard calibration curve. Commercially available controls that are used include a pain management control (e.g., UTAK PM 100, purchased from UTAK laboratories and reconstituted as per manufacturer's instructions) and BioRad C3. Any result greater than ±30% of the established mean value is considered to be “out of limits”, under which circumstances the sample may be re-injected once along with a control; and if still out of limits, then re-analyzed.

A variety of mass analyzers can be used in LC/MS. Exemplary mass analyzers include Single Quadrupole, Triple Quadrupole, Ion Trap, time of Flight (TOF) and Quadrupole-time of flight (Q-TOF). In one embodiment, the mass spectrometer used is a triple quadrupole mass spectrometer (LC/MS/MS). The first (Q1) and third (Q3) quadrupoles act as mass filters, and the middle (Q2) quadrupole is employed as a collision cell. This collision cell is an RF only quadrupole (non-mass filtering) using Ar, He or N gas (˜10⁻³ Ton, ˜30 eV) to cause collision induced dissociation of selected parent ion(s) from Q1. Nitrogen is preferred as the collision gas for its non-reactive and inert properties, as well as lower cost compared to Argon.

The precursor ion is isolated using the first quadrupole and continues on to the collision cell for fragmentation. Fragment ions are derived directly from the precursor and therefore have an unequivocal association to the structure of the precursor molecule. Analyte specific precursor and product ions are thus selected and monitored. This type of analysis is referred to as Selected Reaction Monitoring (SRM). Analysis of multiple SRMs for the same precursor ion is termed Multiple Reaction Monitoring (MRM).

A technique known as Dynamic-MRM® (D-MRM) acquisition can provide a rapid means to develop well-optimized multi-analyte LC/MS/MS methods. Utilizing analyte retention times, detection windows (Delta RT), and a constant scan cycle time, D-MRM software automatically constructs D-MRM timetables for the precise detection of multiple analytes as they chromatographically elute. One of the benefits of D-MRM is that it allows for longer dwell times by performing MRM transitions at approximately the elution time of the analyte.

Multiple classes of drugs can be analyzed simultaneously in less than about 13 minutes, preferably less than about 11 minutes, more preferably less than about 10 minutes, more preferably less than about 9 minutes, most preferably less than about 8 minutes, using the instrumentation and techniques described above. In a preferred embodiment, the analysis time is less than 8 minutes.

The methods described herein allow for the analysis of multiple drug classes in a very short amount of time. This is an improvement over the prior art which analyzes a single drug class at a time due to the inability to achieve adequate separation of different drug classes for analysis. Moreover, failure of the control can occur during testing for analytes in vivo. If a control fails for a single class, only that control needs to be repeated. Thus, the prior art methods require immense time and resources to complete the analysis of multiple drug classes.

In contrast, the claimed methods achieve excellent separation of multiple drug classes so that the different classes can be analyzed simultaneously. The ability to analyze multiple classes of drugs simultaneously significantly reduces the analysis time and thus reduces the cost of analysis.

### BRIEF DESCRIPTION OF THE DRAWINGS

FIG. 1A is a THCA calibration curve. FIG. 1B is a chromatogram showing the retention time and chromatographic peak quality of THCA in an extracted urine calibrator 3. FIG. 1C is a chromatogram showing THCA-D3 internal standard in an extracted urine sample containing calibrator 3. FIG. 1D is a chromatogram showing THCA in an extracted urine sample containing BioRad C3 as a control. FIG. 1E is a chromatogram showing THCA-D3 internal standard in an extracted urine sample containing BioRad C3 as a control.

FIG. 2A is a benzoylecgonine calibration curve. FIG. 2B is a chromatogram showing the retention time and chromatographic peak quality of benzoylecgonine in an extracted urine calibrator 3. FIG. 2C is a chromatogram showing benzoylecgonine-D3 internal standard in an extracted urine sample containing calibrator 3. FIG. 2D is a chromatogram showing benzoylecgonine in an extracted urine sample containing BioRad C3 as a control. FIG. 2E is a chromatogram showing benzoylecgonine-D3 internal standard in an extracted urine sample containing BioRad C3 as a control.

FIG. 3A is a methamphetamine calibration curve. FIG. 3B is a chromatogram showing the retention time and chromatographic peak quality of methamphetamine in an extracted urine calibrator 3. FIG. 3C is a chromatogram showing methamphetamine-D3 internal standard in an extracted urine sample containing calibrator 3. FIG. 3D is a chromatogram showing methamphetamine in an extracted urine sample containing BioRad C3 as a control. FIG. 3E is a chromatogram showing methamphetamine-D3 internal standard in an extracted urine sample containing BioRad C3 as a control.

FIG. 4A is an oxycodone calibration curve. FIG. 4B is a chromatogram showing the retention time and chromatographic peak quality of oxycodone in an extracted urine calibrator 3. FIG. 4C is a chromatogram showing oxycodone-D6 internal standard in an extracted urine sample containing calibrator 3. FIG. 4D is a chromatogram showing oxycodone in an extracted urine sample containing UTAK PM 100 as a control. FIG. 4E is a chromatogram showing oxycodone-D6 internal standard in an extracted urine sample containing UTAK PM 100 as a control.

FIG. 5A is a hydrocodone calibration curve. FIG. 5B is a chromatogram showing the retention time and chromatographic peak quality of hydrocodone in an extracted urine calibrator 3. FIG. 5C is a chromatogram showing hydrocodone-D6 internal standard in an extracted urine sample containing calibrator 3. FIG. 5D is a chromatogram showing hydrocodone in an extracted urine sample containing UTAK PM 100 as a control. FIG. 5E is a chromatogram showing hydrocodone-D6 internal standard in an extracted urine sample containing UTAK PM 100 as a control.

FIG. 6A is a morphine calibration curve. FIG. 6B is a chromatogram showing the retention time and chromatographic peak quality of morphine in an extracted urine calibrator 3. FIG. 6C is a chromatogram showing morphine-D3 internal standard in an extracted urine sample containing calibrator 3. FIG. 6D is a chromatogram showing morphine in an extracted urine sample containing UTAK PM 100 as a control. FIG. 6E is a chromatogram showing morphine-D3 internal standard in an extracted urine sample containing UTAK PM 100 as a control.

FIG. 7A is a nordiazepam calibration curve. FIG. 7B is a chromatogram showing the retention time and chromatographic peak quality of nordiazepam in an extracted urine calibrator 3. FIG. 7C is a chromatogram showing nordiazepam-D5 internal standard in an extracted urine sample containing calibrator 3. FIG. 7D is a chromatogram showing nordiazepam in an extracted urine sample containing BioRad C3 as a control. FIG. 7E is a chromatogram showing nordiazepam-D5 internal standard in an extracted urine sample containing BioRad C3 as a control.

FIG. 8A is an alpha-OH-alprazolam calibration curve. FIG. 8B is a chromatogram showing the retention time and chromatographic peak quality of alpha-OH-alprazolam in an extracted urine calibrator 3. FIG. 8C is a chromatogram showing alpha-OH-alprazolam-D5 in an extracted urine calibrator 3. FIG. 8D is a chromatogram showing alpha-OH-alprazolam in an extracted urine UTAK Benzo Plus control. FIG. 8E is a chromatogram showing alpha-OH-alprazolam-D5 internal standard in an extracted urine sample UTAK Benzo Plus control.

FIG. 9A is a carisoprodol calibration curve. FIG. 9B is a chromatogram showing the retention time and chromatographic peak quality of carisoprodol in an extracted urine calibrator 3. FIG. 9C is a chromatogram showing carisoprodol-D7 in an extracted urine calibrator 3. FIG. 9D is a chromatogram showing carisoprodol in an extracted urine in-house control. FIG. 9E is a chromatogram showing carisoprodol-D7 internal standard in an extracted urine sample in-house control.

### DETAILED DESCRIPTION OF THE INVENTION

### I. Method for the Simultaneous Detection of Multiple Substances in a Biological Sample

Methods for simultaneously detecting multiple drug classes in a biological sample are described herein. In one embodiment, the biological sample is taken from an animal. In a preferred embodiment, the animal is a mammal. Exemplary mammals include humans and livestock, such as horses and cattle. In a particularly embodiment, the mammal is a human.

Suitable classes of drugs include drugs that are prone to abuse and prescription medications. Exemplary drugs prone to abuse include marijuana; opioid analgesics, such as oxycodone, hydrocodone, and morphine; cocaine, and stimulants, such as methamphetamine. Exemplary prescription medications include, but are not limited to, medication used to treat mental illness, such as tricylic antidepressants.

Multiple classes of drugs can be analyzed simultaneously in less than about 13 minutes, preferably less than about 11 minutes, more preferably less than about 10 minutes, more preferably less than about 9 minutes, most preferably less than about 8 minutes.

A. Sample Preparation

The biological sample to be analyzed may be treated prior to analysis. In one embodiment, the biological sample is a urine sample or other bodily fluid or substance, such as saliva, blood, or tissue, which is to be analyzed for the presence of multiple drugs, such as prescription drugs, illicit drugs, metabolites thereof, and/or combinations thereof. The sample volume is typically greater than 1 ml of the biological sample, e.g., urine. However, the sample volume can be varied based on a number of factors

In one embodiment, the biological sample is treated with an enzyme to hydrolyze the sample in order to liberate the free drug. In a particular embodiment, the biological sample is enzymatically hydrolyzed with a glucuronidase, such as from E. coli, to liberate free drug for analysis. The sample and glucuronidase are incubated, e.g., for about three to four hours, at elevated temperature, e.g., about 50-55° C. Glucuronidase-catalyzed hydrolysis is generally required for any sample where glucuronidase metabolites are present. After incubation, the samples are typically cooled to room temperature and transferred to an appropriate substrate, such as a multi-well plate, for solid phase extraction (SPE). For the analysis of oral fluid, enzymatic hydrolysis is typically not required.

B. Solid Phase Extraction

Once the biological sample has been prepared, the sample is extracted using solid-phase extraction (SPE). Solid-phase extraction (SPE) is a separation process by which compounds that are dissolved or suspended in a liquid are separated from other compounds in the mixture according to their physical and chemical properties. SPE can be used to concentrate and/or purify samples for analysis. Solid phase extraction can be used to isolate analytes of interest from a wide variety of matrices, including urine, blood, saliva, and tissue.

SPE uses the affinity of solutes dissolved or suspended in a liquid (i.e., the mobile phase) for a solid (i.e., the stationary phase) through which the sample is passed to separate a mixture into desired and undesired components. The result is that either the desired analytes of interest or undesired impurities in the sample are retained on the stationary phase. The portion that passes through the stationary phase is collected or discarded, depending on whether it contains the desired analytes or undesired impurities. If the portion retained on the stationary phase includes the desired analytes, the analytes can be removed from the stationary phase for collection in an additional step, in which the stationary phase is rinsed with an appropriate eluent.

The stationary phase can come in a variety of forms, such as packed syringe-shaped cartridges, 96 well plates, optionally in which cartridges containing the stationary phase snap into place in the wells, or a 47- or 90-mm flat disk, each of which can be mounted on a specific type of extraction manifold. The manifold allows multiple samples to be processed by holding several SPE media in place and allowing for an equal number of samples to pass through them simultaneously. A typical cartridge SPE manifold can accommodate up to 24 cartridges, while a typical disk SPE manifold can accommodate 6 disks. Most SPE manifolds are equipped with a vacuum port. Application of vacuum speeds up the extraction process by pulling the liquid sample through the stationary phase. The analytes are collected in sample tubes inside or below the manifold after they pass through the stationary phase.

In one embodiment, the stationary phase is in the form of a 96 well plate in which cartridges containing the stationary phase snap into place in the wells. In a particular embodiment, the stationary phase is a Varian Versaplate 96 well-C8 plate combined with a Varian Versaplate manifold.

Solid phase extraction cartridges, disks, and/or plates are available with a variety of stationary phases, each of which can separate analytes according to different chemical properties. Most stationary phases are based on silica derivatized with particular functional groups. Some of these functional groups include hydrocarbon chains of variable length (for reversed phase SPE), quaternary ammonium or amino groups (for anion exchange), and sulfonic acid or carboxyl groups (for cation exchange). Other stationary phases include polymeric materials.

Normal Phase SPE Procedure

A typical solid phase extraction involves four steps. First, the cartridge or well is equilibrated with a non-polar or slightly polar solvent, which wets the surface and penetrates the bonded phase. Water or buffer of the same composition as the sample is typically washed through the column to wet the silica surface. The sample is then added to the cartridge or well. As the sample passes through the stationary phase, the analytes in the sample will interact and retain on the sorbent while the solvent, salts, and other impurities pass through the cartridge or plate. After the sample is loaded, the cartridge is washed with buffer or solvent to remove further impurities. Then, the analyte is eluted with a non-polar solvent or a buffer of the appropriate pH.

In normal phase SPE procedures, a stationary phase of polar functionally bonded silicas with short carbons chains frequently makes up the solid phase. This stationary phase will adsorb polar molecules which can be collected with a more polar solvent.

Reversed Phase SPE

Reversed phase SPE separates analytes based on their polarity. The stationary phase of a reversed phase SPE cartridge or well is derivatized with hydrocarbon chains, which retain compounds of mid to low polarity due to the hydrophobic effect. The analyte can be eluted by washing the cartridge with a non-polar solvent, which disrupts the interaction of the analyte and the stationary phase.

In reversed phase SPE, a stationary phase of silicon with carbon chains is commonly used. Relying on mainly non-polar, hydrophobic interactions, only non-polar or very weakly polar compounds will adsorb to the surface.

Ion Exchange SPE

Ion exchange sorbents separate analytes based on electrostatic interactions between the analyte of interest and the positively charged groups on the stationary phase. For ion exchange to occur, both the stationary phase and sample must be at a pH where both are charged.

Anion Exchange

Anion exchange sorbents are derivatized with positively charged functional groups that interact and retain negatively charged anions, such as acids. Strong anion exchange sorbents contain quaternary ammonium groups that have a permanent positive charge in aqueous solutions, and weak anion exchange sorbents use amine groups which are charged when the pH is below about 9. Strong anion exchange sorbents are useful because any strongly acidic impurities in the sample will bind to the sorbent and usually will not be eluted with the analyte of interest; to recover a strong acid a weak anion exchange cartridge should be used. To elute the analyte from either the strong or weak sorbent, the stationary phase is washed with a solvent that neutralizes the charge of the analyte, the stationary phase, or both. Once the charge is neutralized, the electrostatic interaction between the analyte and the stationary phase no longer exists and the analyte will elute from the cartridge.

Cation Exchange

Cation exchange sorbents are derivatized with functional groups that interact and retain positively charged cations, such as bases. Strong cation exchange sorbents contain aliphatic sulfonic acid groups that are always negatively charged in aqueous solution, and weak cation exchange sorbents contain aliphatic carboxylic acids, which are charged when the pH is above about 5. Strong cation exchange sorbents are useful because any strongly basic impurities in the sample will bind to the sorbent and usually will not be eluted with the analyte of interest; to recover a strong base a weak cation exchange cartridge should be used. To elute the analyte from either the strong or weak sorbent, the stationary phase is washed with a solvent that neutralizes ionic interactions between the analyte and the stationary phase.

In one embodiment, the solid phase extraction is done at neutral or near neutral pH in order to retain the analytes of interest on the solid phase. The solid phase is then washed with an appropriate eluent to remove the analytes of interest from the solid phase. The mixture of analytes is then injected into the LC/MS/MS.

C. Separation/Mass Analysis

Following solid phase extraction (SPE), the resulting eluate containing the compounds to be detected is diluted and injected into a liquid chromatograph coupled to a triple quadrupole mass spectrometer.

Liquid chromatography-mass spectrometry (LC/MS, or alternatively HPLC/MS) is an analytical chemistry technique that combines the physical separation capabilities of liquid chromatography (or HPLC) with the mass analysis capabilities of mass spectrometry. LC/MS is a powerful technique used for many applications which require high sensitivity and specificity.

A difference between traditional HPLC and the chromatography used in LC/MS is that in the latter case the scale is usually much smaller, both with respect to the internal diameter of the column and the flow rate since it scales as the square of the diameter. Traditionally, 1 mm columns were typical for LC/MS work (as opposed to 4.6 mm for HPLC). More recently 300 μm and even 75 μm capillary columns have become more prevalent. At the low end of these column diameters the flow rates approach 100 nL/min and are generally used with nanospray sources.

LC/MS and LC/MS/MS involve the interface of a liquid phase technique (LC) with a gas phase technique carried out in a vacuum (MS or MS/MS). The interface is most often an electrospray ion source (ESI) or variant such as a nanospray source; however fast atom bombardment, thermospray and atmospheric pressure chemical ionization interfaces can also be used. Various deposition and drying techniques have also been used such as using moving belts.

Liquid Chromatography

In one embodiment, LC is performed using a Zorbax Eclipse Plus Rapid Resolution HT C18 3.0×50 mm×1.8 μm column. The column temperature is 50° C. and the injection volume is 10 μL. The pump program has two solvent systems: solvent system A, containing deionized water containing 0.1% formic acid and 0.1% ammonium formate and solvent system B, containing methanol containing 0.1% formic acid. The solvent flow rate is 0.6 mL/minute. In one embodiment, at time 0 minutes, the liquid phase is 90% solvent system A and 10% solvent system B. An initial gradient program is run to 4.4 minutes, in which the liquid phase is set to 20% solvent system A and 80% solvent system B. At 4.4 minutes, a second gradient is then run in which the liquid phase is set to 5% solvent A and 95% solvent B and ending at 6.5 minutes. A 1.3 minute recovery (post-time) is then run for a total run time of 7.8 minutes Retention times are expressed in minutes.

Analytical Parameters

Four calibrators, referred to as calibrators 1-4, are analyzed to generate a standard calibration curve. These calibrators are spiked standards, generally prepared in house, which are used to generate the standard calibration curve for the particular drug or metabolite to be analyzed. Each sample is read against the standard curve in order to obtain a value. The use of four calibrators allows for the exclusion of one (and only one) data point, if necessary, while maintaining a valid calibration curve.

Calibrator 1:10 is a dilution of the lowest concentration calibrator and can be used to monitor the detection of low concentrations of a drug or metabolite thereof by validating the standard calibration curve at low concentrations.

At least one control for each drug being analyzed is also used. These controls are commercially available from outside vendors or can be prepared in house and are used to confirm the standard calibration curve. The results are measured against the standard calibration curve. Commercially available controls that are used include a Pain Management Control (e.g., UTAK PM 100, purchased from UTAK laboratories and reconstituted as per manufacturer's instructions) and BioRad C3. A result greater than ±30% of the established mean value was reported as “out of limits”, under which circumstances the sample was re-injected once along with a control; and if still out of limits, then the sample was re-analyzed.

Mass Analyzer

A variety of mass analyzers can be used in LC/MS. Exemplary mass analyzers include Single Quadrupole, Triple Quadrupole, Ion Trap, time of Flight (TOF) and Quadrupole-time of flight (Q-TOF).

The quadrupole mass analyzer is one type of mass analyzer used in mass spectrometry. As the name implies, it consists of 4 circular rods, set parallel to each other. In a Quadrupole Mass Spectrometer (QMS) the quadrupole is the component of the instrument responsible for filtering sample ions, based on their mass-to-charge ratio (m/z). Ions are separated in a quadrupole based on the stability of their trajectories in the oscillating electric fields that are applied to the rods.

The quadrupole consists of four parallel metal rods. Each opposing rod pair is connected together electrically, and a radio frequency (RF) voltage is applied between one pair of rods and the other. A direct current voltage is then superimposed on the RF voltage. Ions travel down the quadrupole between the rods. Only ions of a certain mass-to-charge ratio m/z will reach the detector for a given ratio of voltages: other ions have unstable trajectories and will collide with the rods. This permits selection of an ion with a particular m/z or allows the operator to scan for a range of m/z-values by continuously varying the applied voltage.

Ideally the rods are hyperbolic. Circular rods with a specific ratio of rod diameter-to-spacing provide an easier-to-manufacture adequate approximation to hyperbolas. Small variations in the ratio have large effects on resolution and peak shape. Different manufacturers choose slightly different ratios to fine-tune operating characteristics in context of anticipated application requirements. In recent decades some manufacturers have produced quadrupole mass spectrometers with true hyperbolic rods.

These mass spectrometers excel at applications where particular ions of interest are being studied because they can stay tuned on a single ion for extended periods of time. This is useful is in liquid chromatography-mass spectrometry or gas chromatography-mass spectrometry where they serve as exceptionally high specificity detectors.

Triple Quadrupole Mass Analyzers

A triple quadrupole mass spectrometer involves a linear series of three quadrupoles. The first (Q1) and third (Q3) quadrupoles act as mass filters, and the middle (q2) quadrupole is employed as a collision cell. This collision cell is an RF only quadrupole (non-mass filtering) using Ar, He or N gas (˜10⁻³ Torr, ˜30 eV) to cause collision induced dissociation of selected parent ion(s) from Q1. Subsequent fragments are passed through to Q3 where they may be filtered or scanned fully.

This process allows for the study of fragments (daughter ions) which are crucial in structural elucidation. For example, the Q1 may be set to “filter” for a drug ion of a known mass, which is fragmented in Q2. The third quadrupole (Q3) can then be set to scan the entire m/z range, giving information on the sizes of the fragments made. Thus, the structure of the original ion can be deduced.

In one embodiment, the urine samples are hydrolyzed to liberate free drug, for example, by reaction with a glucuronidase. The hydrolyzed samples are extracted using solid phase extraction. In a preferred embodiment, the solid phase extraction is done using a multi-well solid phase extraction column plate. The extracts are diluted and injected into the LC/MS for analysis.

Nitrogen is preferred as the collision gas for its non-reactive and inert properties, as well as lower cost compared to Argon. The precursor ion is isolated using the first quadrupole and continues on to the collision cell for fragmentation. Fragment ions are derived directly from the precursor and therefore have an unequivocal association to the structure of the precursor molecule. Analyte specific precursor and product ions are thus selected and monitored. This type of analysis is referred to as Selected Reaction Monitoring (SRM). Analysis of multiple SRMs for the same precursor ion is termed Multiple Reaction Monitoring (MRM).

A technique known as Dynamic-MRM® (D-MRM) acquisition can provides a rapid means to develop well-optimized multi-analyte LC/MS/MS methods. Utilizing analyte retention times, detection windows (Delta RT), and a constant scan cycle time, D-MRM software automatically constructs D-MRM timetables for the precise detection of multiple analytes as they chromatographically elute. One of the benefits of D-MRM is that it allows for longer dwell times by performing MRM transitions at approximately the elution time of the analyte.

In one embodiment, the ion source is Electrospray Ionization. The MS/MS conditions are Gas Temp at 350° C., Gas Flow set to 13 L/min, Nebulizer at 35 psi, Capillary Voltage at 4000 v and Delta EMV set to 400 v above tune voltage in the Positive Mode.

D. Compounds to be Detected

Any number of different substances can be simultaneously detected using the methods described herein. In one embodiment, the substances to be detected include drugs prone to abuse, such as prescription medications and metabolites thereof, illicit drugs and metabolites thereof, and combinations thereof. Drugs prone to abuse refer to controlled substances specified as schedule II, II, IV and V drugs. In a particular embodiment, the prescription medications and/or illicit drugs are those used to treat pain, such as opioid analgesics.

Exemplary compounds include, but are not limited to, 1-phenylcyclohexylamine, 1-piperidinocyclohexanecarbonitrile, alfentanil, alphacetylmethadol, alphaprodine, alprazolam, amobarbital, amphetamine, anileridine, apomorphine, aprobarbital, barbital, barbituric acid derivative, bemidone, benzoylecgonine, benzphetamine, betacetylmethadol, betaprodine, bezitramide, bromazepam, buprenorphine, butabarbital, butalbital, butorphanol, camazepam, cathine, chloral, chlordiazepoxide, clobazam, clonazepam, clorazepate, clotiazepam, cloxazolam, cocaine, codeine, chlorphentermine, delorazepam, dexfenfluramine, dextromoramide, dextropropoxyphen, dezocine, diazepam, diethylpropion, difenoxin, dihydrocodeine, dihydromorphine, dioxaphentyl butyrate, dipanone, diphenoxylate, diprenorphine, ecgonine, enadoline, eptazocine, estazolam, ethoheptazine, ethyl loflazepate, ethylmorphine, etorphine, femproponex, fencamfamin, fenfluramine, fentanyl, fludiazepam, flunitrazepam, flurazepam, glutethimide, halazepam, haloxazolam, hexylgon, hydrocodone, hydromorphone, isomethadone, hydrocodone, ketamine, ketazolam, ketobemidone, levanone, levoalphacetylmethadol, levomethadone, levomethadyl acetate, levomethorphan, levorphanol, lofentanil, loperamide, loprazolam, lorazepam, lormetazepam, lysergic acid, lysergic acid amide, mazindol, medazepam, mefenorex, meperidine, meptazinol, metazocine, methadone, methamphetamine, methohexital, methotrimeprazine, methyldihydromorphinone, methylphenidate, methylphenobarbital, metopon, morphine, nabilone, nalbuphine, nalbupine, nalorphine, narceine, nefopam, nicomorphine, nimetazepam, nitrazepam, nordiazepam, normethadone, normorphine, oxazepam, oxazolam, oxycodone, oxymorphone, pentazocine, pentobarbital, phenadoxone, phenazocine, phencyclidine, phendimetrazine, phenmetrazine, pheneridine, piminodine, prodilidine, properidine, propoxyphene, racemethorphan, racemorphan, racemoramide, remifentanil, secobarbital, sufentanil, talbutal, thebaine, thiamylal, thiopental, tramadol, trimeperidine, and vinbarbital.

In addition to the compounds above, the following scheduled drugs may also be detected: allobarbitone, alprazolam, amylobarbitone, aprobarbital, barbital, barbitone, benzphetamine, brallobarbital, bromazepam, brotizolam, buspirone, butalbital, butobarbitone, butorphanol, camazepam, captodiame, carbromal, carfentanil, carpipramine, cathine, chloral, chloral betaine, chloral hydrate, chloralose, chlordiazepoxide, chlorhexadol, chlormethiazole edisylate, chlormezanone, cinolazepam, clobazam, potassium clorazepate, clotiazepam, cloxazolam, cyclobarbitone, delorazepam, dexfenfluramine, diazepam, diethylpropion, difebarbamate, difenoxin, enciprazine, estazolam, ethyl loflazepate, etizolam, febarbamate, fencamfamin, fenfluramine, fenproporex, fluanisone, fludiazepam, flunitraam, flunitrazepam, flurazepam, flutoprazepam, gepirone, glutethimide, halazepam, haloxazolam, hexobarbitone, ibomal, ipsapirone, ketazolam, loprazolam mesylate, lorazepam, lormetazepam, mazindol, mebutamate, medazepam, mefenorex, mephobarbital, meprobamate, metaclazepam, methaqualone, methohexital, methylpentynol, methylphenobarbital, midazolam, milazolam, nimetazepam, nitrazepam, nordiazepam, oxazepam, oxazolam, paraldehyde, pemoline, pentabarbitone, pentazocine, pentobarbital, phencyclidine, phenobarbital, phendimetrazine, phenmetrazine, phenprobamate, phentermine, phenyacetone, pinazepam, pipradol, prazepam, proxibarbal, quazepam, quinalbaritone, secobarbital, secbutobarbitone, sibutramine, temazepam, tetrazepam, triazolam, triclofos, zalepan, zaleplon, zolazepam, zolpidem, and zopiclone.

In one embodiment compounds to be detected include morphine, oxymorphone, hydromorphone, codeine, oxycodone, hydrocodone, 6-MAM, MDMA, MDA, o-desmethyltramadol, methamphetamine, amphetamine, ritalinic acid, norfentanyl, benzoylecgonine, 7-aminoclonazepam, tramadol, methylphenidate, meperidine, normeperidine, PCP, norbuprenorphine, fentanyl, EDDP, meprobamate, buprenorphine, norpropoxyphene, propoxyphene, imipramine, methadone, desipramine, amitriptyline, nortiptyline, carisoprodol, alpha-OH-alprazolam, lorazepam, oxazepam, temazepam, nordiazepam, diazepam, THCA, tapentadol and combinations thereof.

E. Internals Standards and Controls

Deuterated analytes can be used as internal standards. Exemplary deuterated analytes include, but are not limited to, morphine-D3, oxymorphone-D3, hydromorphone-D3, codeine-D3, oxycodone-D6, 6-MAM-D6, MDMA-D5, methamphetamine-D5, amphetamine-D6, fentanyl-D5, norfentanyl-D5, benzoylecgonine-D3, 7-aminoclonazepam-D4, tramadol-D3, methylphenidate-D9, meperidine-D4, normeperidine-D4, PCP-D5, norbuprenorphine-D3, meprobamate-D7, buprenorphine-D4, propoxyphene-D5, Imipramine-D3, methadone-D3, Desipramine-D3, nortiptyline-D3, carisoprodol-D7, alpha-OH-alprazolam-D5, lorazepam-D4, oxazepam-D5, nordiazepam-D5, diazepam-D5, tapentadol-D3 and THCA-D3.

### II. Applications

The methods described herein can be used to analyze biological samples, such as urine, blood, saliva, and/or tissue, to simultaneously detect multiple substances, such as a prescription drugs and/or illicit drugs or metabolites thereof, in the biological sample.

In one embodiment, the methods described herein can be used to detect for the presence of illegal drugs. Entities responsible for drug testing include but are not limited to, law enforcement agencies (e.g., state bureaus of investigation); hospitals; pharmacies; and commercial laboratories which conduct drug testing for employers. In another embodiment, the methods described herein can be used to quantify the amount of prescription medication a patent is taking to determine whether the dosage needs to be adjusted or if the patient is not complying with the dosing regimen.

Three primary identifiers are used to determine a positive result: peak shape and peak retention time (as measured by LC) and a unique mass-ion ratio (“MIR” or comparison of the ration of the quantification transition ion). These identifiers are compared to the identifiers generated from a drug and/or metabolite standard. In one embodiment, the peak shape and retention time vary no more than 5% from that of the standard and the MIR varies no more than 30% from that of the standard. Drug and/or metabolite standards can be purchased commercially or prepared in-house using commercially available reagents. For example, BioRad sells a urine technology control under the trade name Liquichek Urine Toxicology Control, Level C3. Liquichek Urine Toxicology Control, Level C3 is a human urine-based confirmatory control with drugs of abuse at 20-25% above confirmatory cutoffs (2,000 ng/mL opiate cutoff).

In one embodiment, the methods described herein were used to detect drugs used for pain management and/or illicit drugs, such as amphetamines, barbiturates, benzodiazepines, buprenorphine, cannabinoids, metabolites of cocaine, ectasy, EDDP (methadone metabolite), ethyl alcohol, 6-AM (heroin metabolite), methadone, opiates, oxycodone, PCP, and propoxyphene.

A patient specific list of drugs for LC/MS/MS testing can be produced by integrating the prescription drug regimen, if any, submitted by the patient's physician(s) and presumptive positive initial test results.

The methods described herein can be used to simultaneously detect 2, 3, 4, 5, 6, 7, 8, 9, 10, or more drug classes in a single sample in less than 8 minutes. This is a significant improvement over the methods currently used to analyze for substances, particularly prescription and/or illicit drugs, in which several days are required to complete the analysis since each drug class is analyzed separately.

### EXAMPLES

### Reagents

The following reagents were obtained from commercial suppliers as used as provided: Ammonium formate, B-glucuronidase E-coli (Sigma Aldrich, 15 g in 60 mL pH 6.8 buffer and stored at −10° C.), formic acid, hydrochloric acid, methanol, phosphate buffer pH 6.8, and water (deionized-type 1).

Drug Standards

Stock calibrators were purchased from Cerilliant, Inc. and diluted to appropriate concentrations. Four different standards were prepared using the stock calibrator. Stock solutions and aliquots were stable until manufacturer's listed expiration date when stored according to manufacturer's recommendation.

Stock internal standards were prepared from deuterated drug material purchased from Cerilliant and diluted to the appropriate concentrations. Aliqouts of the stock internal standard were stored at −10° C.

Working internal standards were prepared by transferring 2.5 ml of the stock internal standard to a 50 ml volumetric flask SQ to the mark with a pH 6.8 phosphate buffer. Working internal standards were stable for up to 30 days.

Negative and Positive controls were purchased from UTAK Laboratories (e.g., Pain Management Control-UTAK PM 100) and BioRad Laboratories (e.g., Urine Toxicology Controls) and reconstituted as directed by the manufacturer.

Equipment

The biological samples were purified by solid phase extraction (SPE) using a Varian Versaplate 96-well-C8 plate. The automated extraction device was a TomTec device (e.g., Quadra 4), which is a highly accurate low level liquid delivery system (as low as 25 μL) for 96-well plates using disposable pipette tips, thus obviating any possibility of cross-contamination of samples. The TomTec Quadra 4 automated extraction device also employed a bar-code reader for the accurate identification of each sample being analyzed.

The liquid chromatograph used a Zorbax Eclipse Plus Rapid Resolution HT C18 column having the following dimensions: 3.0×50 mm×1.8 μm. The column temperature was held constant at 50° C. during the analyses. The injection volume was 10 μL.

A triple quadrupole (QQQ) mass spectrometer, such as the Agilent 6400 Series, was used for mass analysis. In the examples below, mass spectrometer model number G6430A using firmware version A.00.05.40 and Data Acquisition software version B.03.01 was used for mass analysis. The ion source is electron spray ionization (ESI). Coupled to the liquid chromatograph/mass spectrometer was an Agilent 1200 Series High Performance Autosampler SL+(firmware version A.00.06.16), an Agilent 1200 Series Binary Pump SL (firmware version A.06.10), and an Agilent 1200 Series Thermostatted Column Compartment SL (firmware version A.00.05.40). Quantitative analysis was carried out using version B.04.00 (Build 4.0.225.2) of the MassHunter® Workstation Quantitative Analysis Software.

### Example 1

### Automated Extraction Procedure

All of the working solutions (e.g., calibrators, controls, and internal standards) were equilibrated to room temperature.

An internal standard mixture was prepared containing buffer (1 mmol with pH adjusted to 6.8 with concentrated HCl as necessary) and drug internal standard to deliver an internal standard concentration greater than the concentration of calibrator 1 and less than the concentration of calibrator 2 per specimen. If a dilution was necessary, the dilution factor used to make the dilution was recorded.

Enzymatic Hydrolysis of the Sample

0.75 mL of specimen was transferred via pipette into the 96-well plate sample wells. 127 μL of glucuronidase was added via pipette to each incubation well. The 96-well was sealed with a VWR Adhesive Foil Seal and placed in an incubator. The 96-well plate was incubated at 55° C. for a minimum of three hours or a maximum of four hours.

Solid Phase Extraction

All working solutions were allowed to equilibrate to room temperature prior to use. Calibration standards and controls are barcoded for identification.

Prior to extraction, the column beds were conditioned using methanol, deionized water, and buffer. The specimens treated with glucuronidase were transferred from the 96-well incubation plate to the corresponding wells on the 96-well extraction plate using the TomTec device. The TomTec Auto Extraction procedure was followed to extract the specimens.

Using the TomTec Quadra 4, each column bed of the 96-well plate was conditioned with 450 μL each of methanol, water and buffer. The column bed was not allowed to go to dryness. Each sample was then added to the appropriate column bed, rinsed with 1.5 mL water and the column allowed to dry. The elution solvent added to each column was 300 μL of methanol-water (80:20), after which was added 1020 μL water for a total volume of approximately 1300 μL. A 3M Empore adhesive seal was applied to the 96-well plate, which was then ready for LC/MS/MS analysis.

A two solvent pump program was used to elute the LC column. Solvent A was deionized water containing 0.1% formic acid and 0.1% ammonium formate. Solvent B was methanol containing 0.1% formic acid. In one embodiment, at time 0 minutes, the liquid phase is 90% solvent system A and 10% solvent system B. An initial gradient program was run to 4.4 minutes, in which the liquid phase was set to 20% solvent system A and 80% solvent system B. At 4.4 minutes, a second gradient was then run in which the liquid phase was set to 5% solvent A and 95% solvent B and ending at 6.5 minutes. A 1.3 minute recovery (post-time) was then run for a total run time of 7.8 minutes. Retention times are expressed in minutes. The pump program can be varied depending on the substances to be analyzed and/or other criteria.

LC/MS/MS Analysis

Four calibrators, referred to as calibrators 1-4, are analyzed to generate a standard calibration curve. These calibrators are spiked standards, generally prepared in house, which are used to generate the standard calibration curve for the particular drug or metabolite to be analyzed. Each sample is read against the standard curve in order to obtain a value. The use of four calibrators allows for the exclusion of one (and only one) data point, if necessary, while maintaining a valid calibration curve.

Additional calibrators can be used which contain additional materials that are not contained in calibrators 1-4. Calibrator 1:10 is a dilution of the lowest concentration calibrator 1-4 and can be used for the detection of low concentrations of a drug or metabolite thereof by validating the standard calibration curve at low concentrations.

At least one control that has each drug that is being screened for is also analyzed. These controls are commercially available from outside vendors or can be prepared in house and are used to confirm the standard calibration curve. The results are measured against the standard calibration curve. Commercially available controls that are used include a pain management control (e.g. UTAK PM 100, purchased from UTAK laboratories and reconstituted as per manufacturer's instructions) and BioRad C3. Any result greater than ±30% of the established mean value was considered to be “out of limits”, under which circumstances the sample was re-injected once along with a control; and if still out of limits, was then re-analyzed.

Below are the data tables for drugs and/or metabolites thereof detected in a biological sample. Chromatograms showing the retention time of the analyte and the shape of the peak are shown in the figures.

TABLE 1
Data table for THCA

| | | THCA Me | THCA Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 5.961 | 0.2437 | 56.5 |
| control | | | | | |
| Calibrator | Cal | 20.0000 | 6.077 | 14.1941 | 30.5 |
| 1 | | | | | |
| Calibrator | Cal | 200.0000 | 6.085 | 174.7792 | 29.7 |
| 2 | | | | | |
| Calibrator | Cal | 500.0000 | 6.085 | 493.2138 | 28.7 |
| 3 | | | | | |
| Calibrator | Cal | 1000.0000 | 6.085 | 1008.5534 | 28.1 |
| 4 | | | | | |
| Calibrator | Sample | | 6.094 | 3.5070 | 29.3 |
| 1:10 | | | | | |
| PM 100 | Sample | | 6.119 | 0.9790 | 35.9 |
| BioRad | Sample | | 6.094 | 23.1294 | 30.2 |
| C3 | | | | | |
| Benz | Sample | | 6.077 | 0.9738 | 38.0 |
| Positive | Sample | | 6.094 | 19.7528 | 31.0 |
| Control | | | | | |

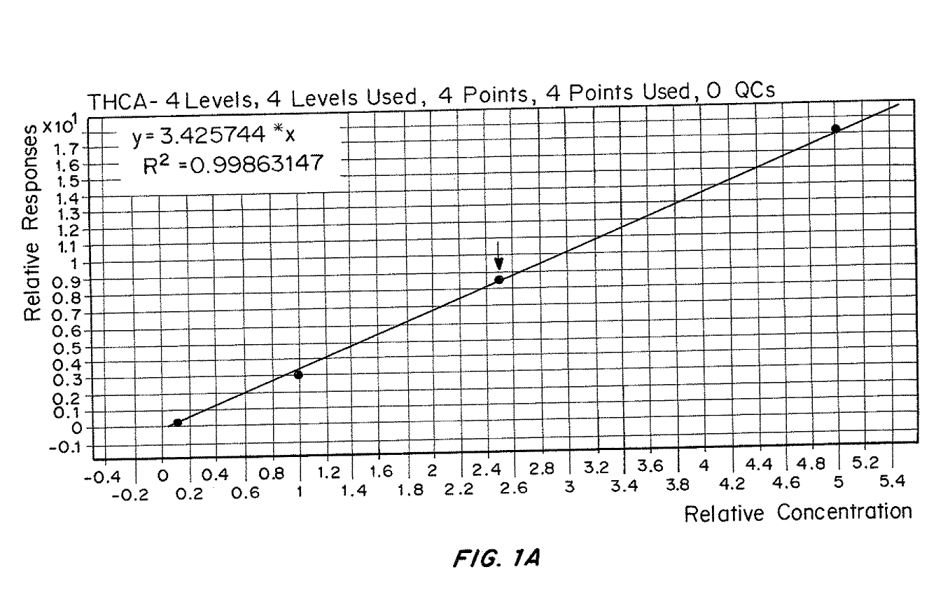

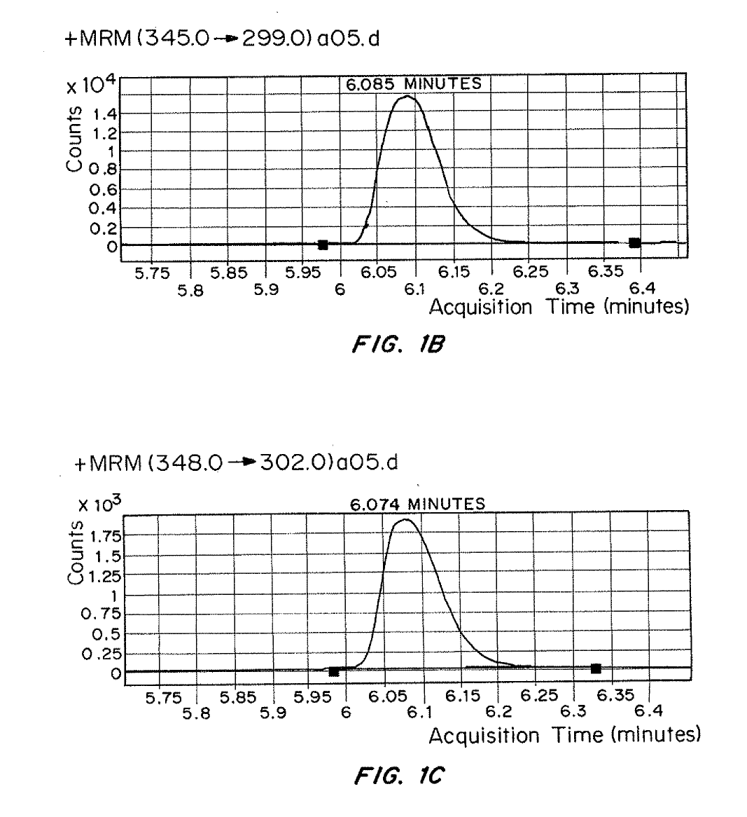

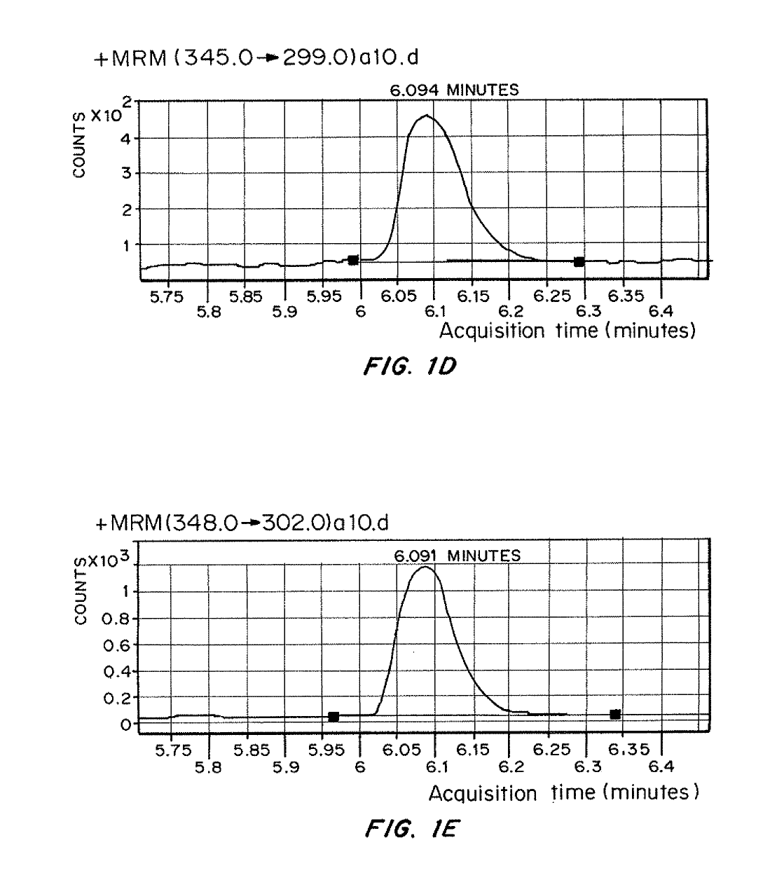

The calibration curve is shown in FIG. 1A. The chromatograms are shown in FIGS. 1B-E.

TABLE 2
Data table for benzoylecgonine (cocaine metabolite)

| | | Benzoyl- | Benzoylecgonine | | |
|---|---|---|---|---|---|
| | | ecgonine | Results | | |
| | | Experimental | | Calculated | |
| Sample | | Concen- | Retention | Concen- | Qualifier |
| Name | Type | tration | Time | tration | Ratio |
| Neg. | Sample | | 2.241 | 0.1351 | 36.1 |
| control | | | | | |
| Calibrator | Cal | 100.0000 | 2.543 | 94.8632 | 24.6 |
| 1 | | | | | |
| Calibrator | Cal | 1000.0000 | 2.551 | 1001.5801 | 24.7 |
| 2 | | | | | |
| Calibrator | Cal | 2500.0000 | 2.543 | 2473.4994 | 24.5 |
| 3 | | | | | |
| Calibrator | Cal | 5000.0000 | 2.551 | 5013.0370 | 24.5 |
| 4 | | | | | |
| Calibrator | Sample | | 2.551 | 10.2531 | 27.4 |
| 1:10 | | | | | |
| PM 100 | Sample | | 2.551 | 0.7470 | 62.7 |
| BioRad | Sample | | 2.551 | 202.1986 | 24.3 |
| C3 | | | | | |
| Benz | Sample | | 2.551 | 0.9418 | 27.8 |
| Positive | Sample | | 2.551 | 346.8199 | 24.7 |
| Control | | | | | |

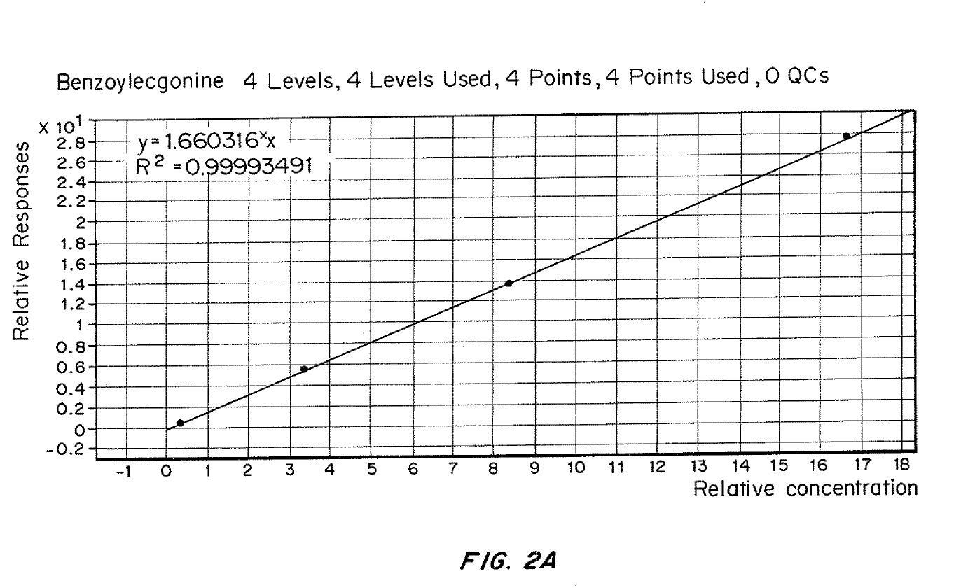

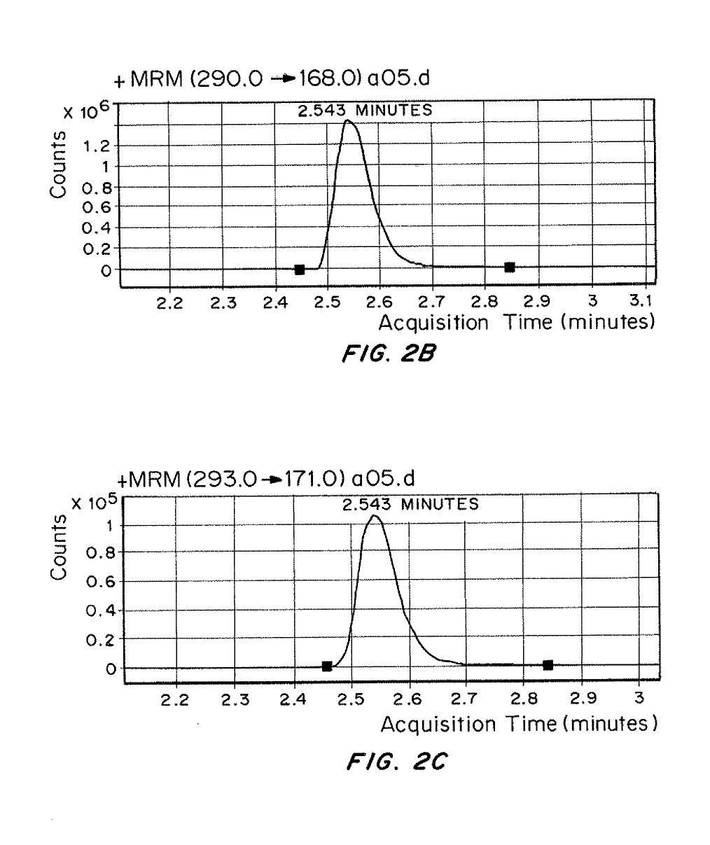

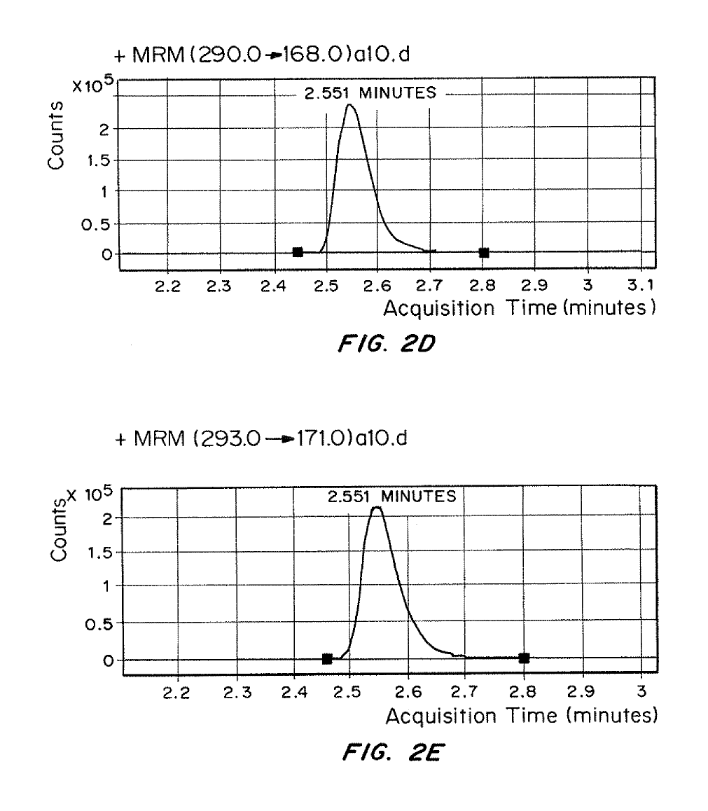

The calibration curve is shown in FIG. 2A. The chromatograms are shown in FIGS. 2B-E.

TABLE 3
Data table for methamphetamine

| | | Metham- | Methamphetamine | | |
|---|---|---|---|---|---|
| | | phetamine | Results | | |
| | | Experimental | | Calculated | |
| Sample | | Concen- | Retention | Concen- | Qualifier |
| Name | Type | tration | Time | tration | Ratio |
| Neg. | Sample | | 2.163 | 0.0626 | 47.0 |
| control | | | | | |
| Calibrator | Cal | 100.0000 | 1.994 | 91.2214 | 33.4 |
| 1 | | | | | |
| Calibrator | Cal | 1000.0000 | 2.002 | 999.2516 | 34.8 |
| 2 | | | | | |
| Calibrator | Cal | 2500.0000 | 1.994 | 2461.4977 | 34.2 |
| 3 | | | | | |
| Calibrator | Cal | 5000.0000 | 1.986 | 5019.5764 | 35.8 |
| 4 | | | | | |
| Calibrator | Sample | | 2.002 | 9.1882 | 31.2 |
| 1:10 | | | | | |
| PM 100 | Sample | | 2.188 | 0.0541 | 2.2 |
| BioRad | Sample | | 2.010 | 610.0382 | 33.8 |
| C3 | | | | | |
| Benz | Sample | | 2.018 | 1.6127 | 41.3 |
| Positive | Sample | | 2.010 | 1557.8493 | 35.1 |
| Control | | | | | |

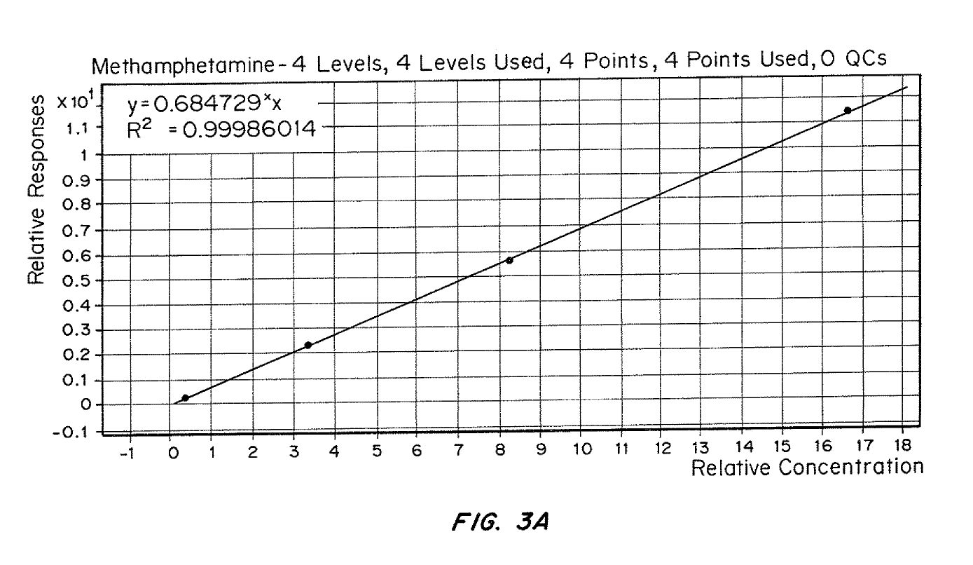

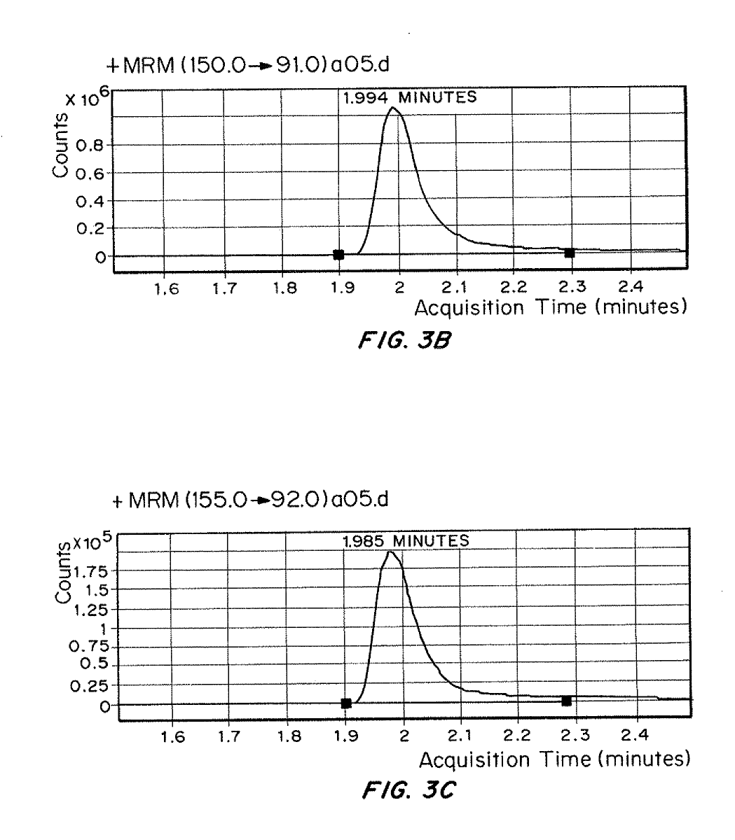

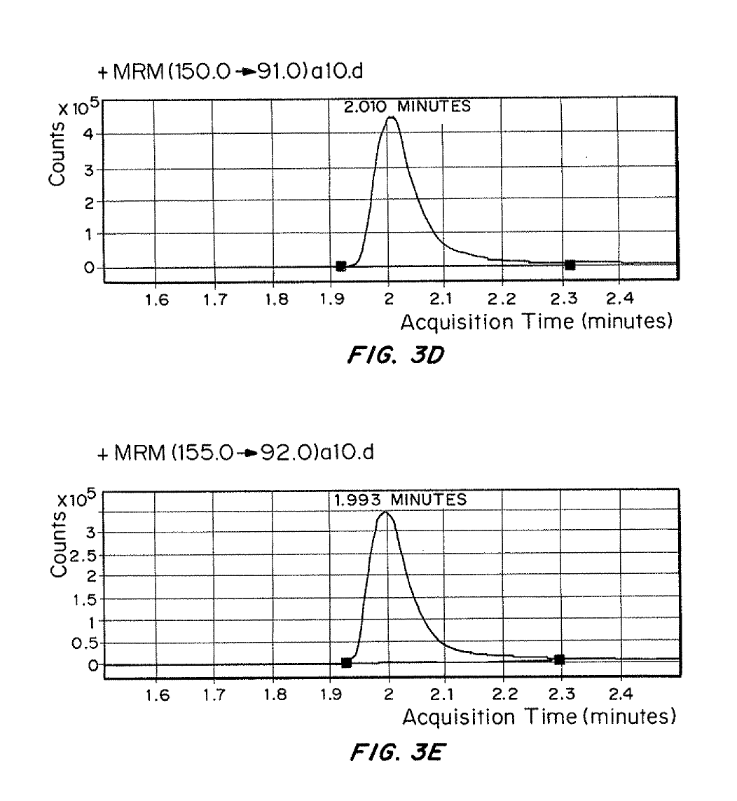

The calibration curve is shown in FIG. 3A. The chromatograms are shown in FIGS. 3B-E.

TABLE 4
Data table for oxycodone

| | | Oxycodone | Oxycodone Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 1.232 | 0.2421 | 16.1 |
| control | | | | | |
| Calibrator | Cal | 100.0000 | 1.691 | 91.9298 | 15.6 |
| 1 | | | | | |
| Calibrator | Cal | 1000.0000 | 1.691 | 992.7417 | 17.3 |
| 2 | | | | | |
| Calibrator | Cal | 2500.0000 | 1.691 | 2542.9949 | 17.4 |
| 3 | | | | | |
| Calibrator | Cal | 5000.0000 | 1.691 | 4980.1156 | 17.3 |
| 4 | | | | | |
| Calibrator | Sample | | 1.691 | 9.5386 | 15.6 |
| 1:10 | | | | | |
| PM 100 | Sample | | 1.691 | 82.3549 | 15.6 |
| BioRad | Sample | | 1.691 | 0.7353 | 26.9 |
| C3 | | | | | |
| Benz | Sample | | 1.996 | 0.3314 | 17.9 |
| Positive | Sample | | 1.669 | 262.0296 | 16.3 |
| Control | | | | | |

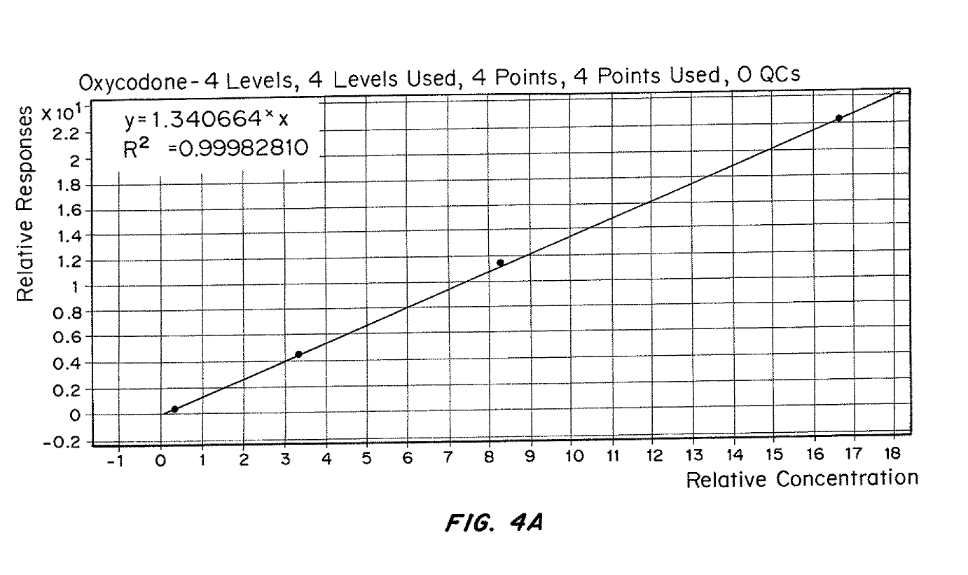

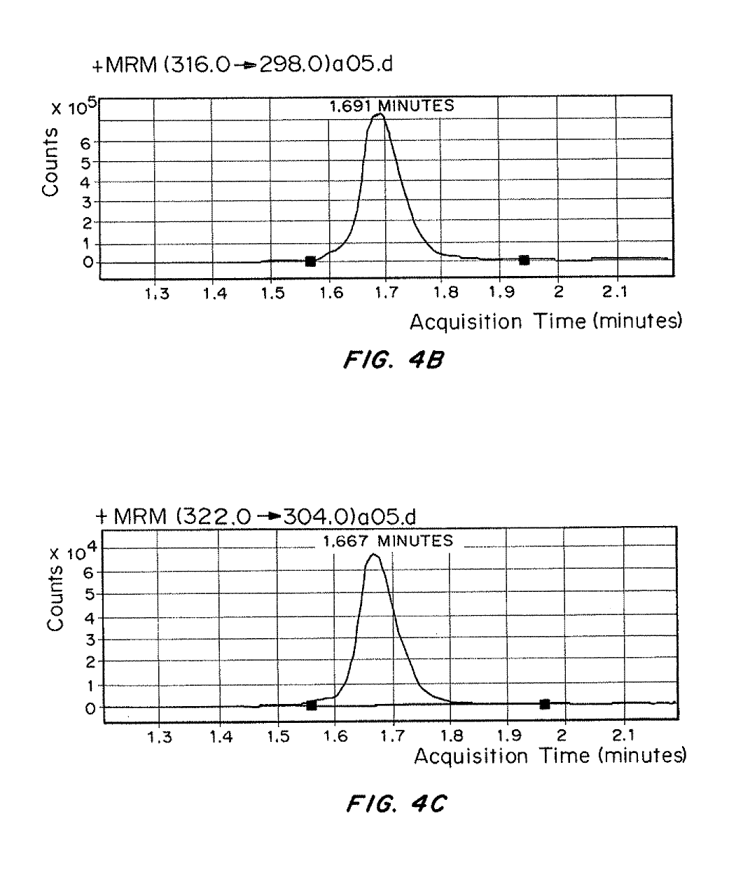

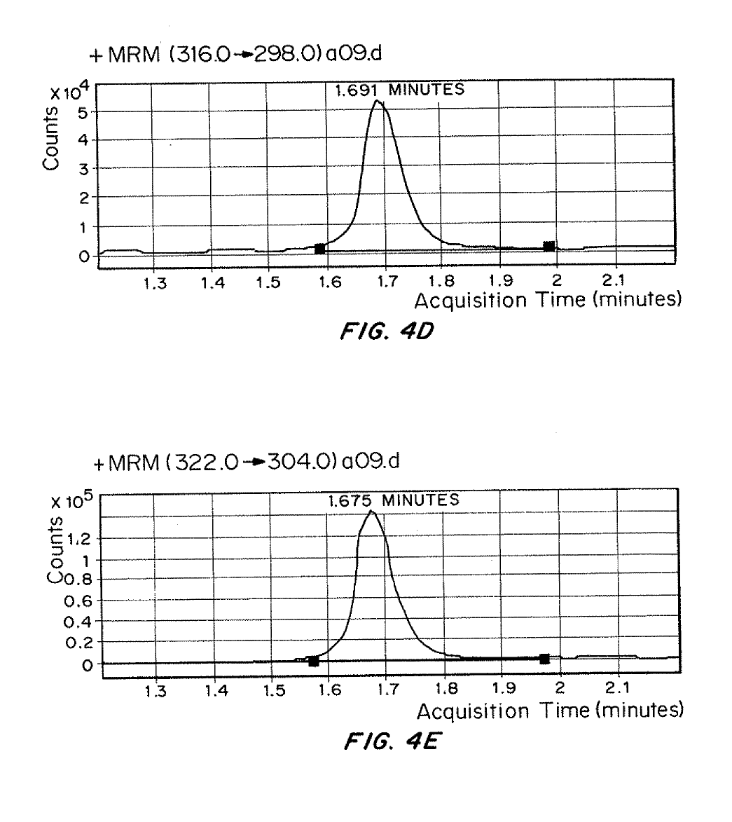

The calibration curve is shown in FIG. 4A. The chromatograms are shown in FIGS. 4B-E.

TABLE 5
Data table for hydrocodone

| | | Hydrocodone | Hydrocodone Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 2.142 | 0.0000 | |
| control | | | | | |
| Calibrator | Cal | 100.0000 | 1..781 | 91.5352 | 49.1 |
| 1 | | | | | |
| Calibrator | Cal | 1000.0000 | 1.789 | 1005.0941 | 48.8 |
| 2 | | | | | |
| Calibrator | Cal | 2500.0000 | 1.781 | 2475.2998 | 49.1 |
| 3 | | | | | |
| Calibrator | Cal | 5000.0000 | 1.781 | 5011.5006 | 49.9 |
| 4 | | | | | |
| Calibrator | Sample | | 1.789 | 9.3193 | 46.5 |
| 1:10 | | | | | |
| PM 100 | Sample | | 1.789 | 81.1238 | 49.3 |
| BioRad | Sample | | 1.556 | 0.0000 | |
| C3 | | | | | |
| Benz | Sample | | 1.781 | 0.0000 | |
| Positive | Sample | | 1.789 | 286.6152 | 47.4 |
| Control | | | | | |

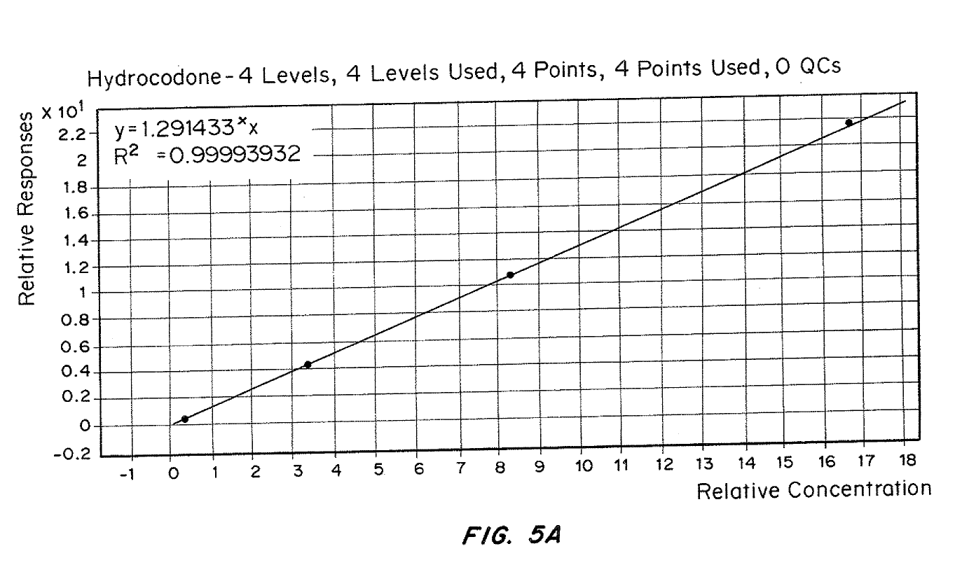

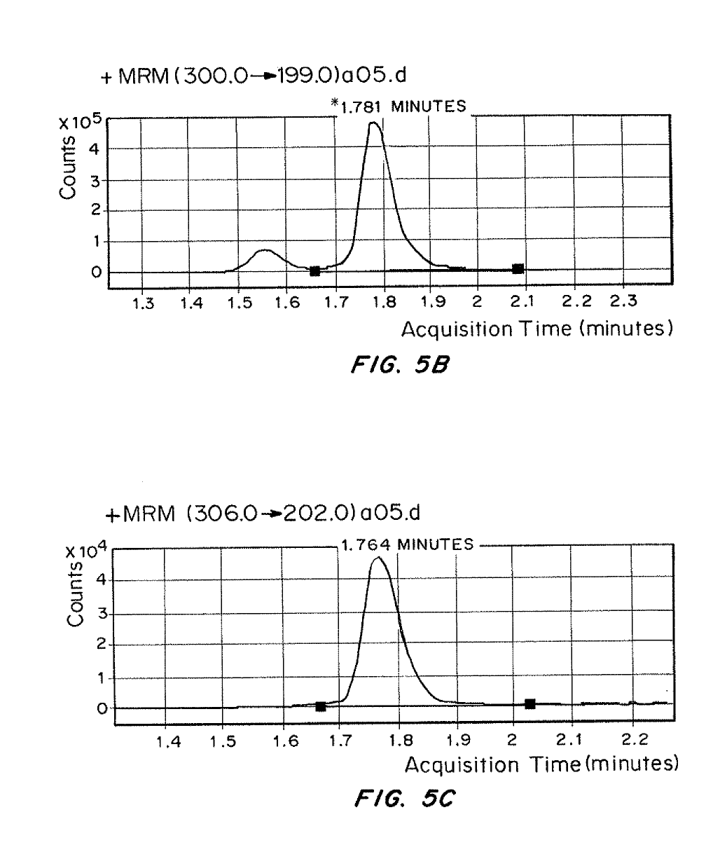

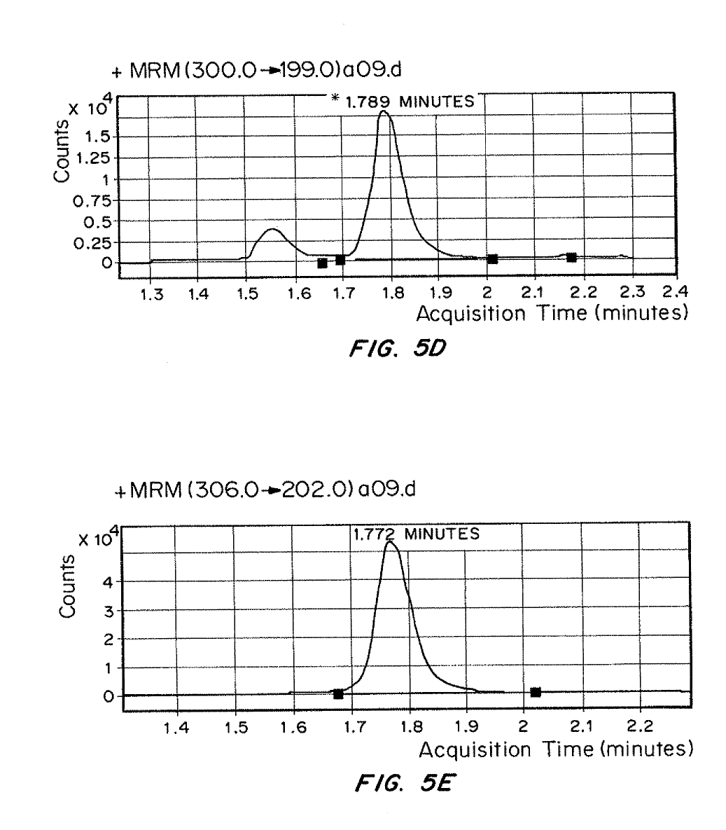

The calibration curve is shown in FIG. 5A. The chromatograms are shown in FIGS. 5B-E.

TABLE 6
Data table for morphine

| | | Morphine | Morphine Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 0.720 | 1.2215 | |
| control | | | | | |
| Calibrator | Cal | 100.0000 | 0.703 | 87.1183 | 64.3 |
| 1 | | | | | |
| Calibrator | Cal | 1000.0000 | 0.703 | 967.6220 | 65.1 |
| 2 | | | | | |
| Calibrator | Cal | 2500.0000 | 0.703 | 2431.3045 | 65.4 |
| 3 | | | | | |
| Calibrator | Cal | 5000.0000 | 0.703 | 5042.8304 | 65.6 |
| 4 | | | | | |
| Calibrator | Sample | | 0.712 | 10.7882 | 67.1 |
| 1:10 | | | | | |
| PM 100 | Sample | | 0.712 | 91.5071 | 61.7 |
| BioRad | Sample | | 0.712 | 256.9782 | 64.0 |
| C3 | | | | | |
| Benz | Sample | | — | — | — |
| Positive | Sample | | 0.712 | 262.4849 | 61.9 |
| Control | | | | | |

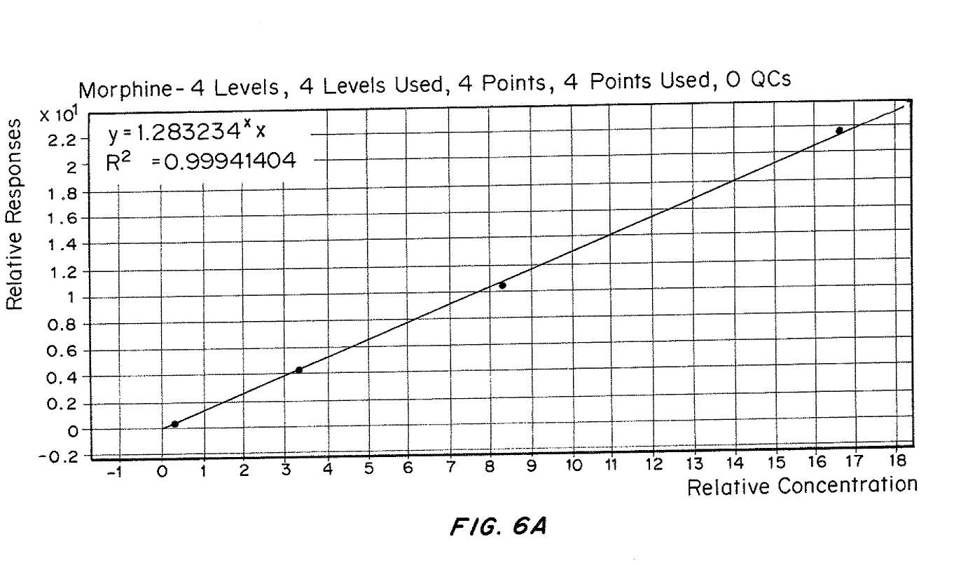

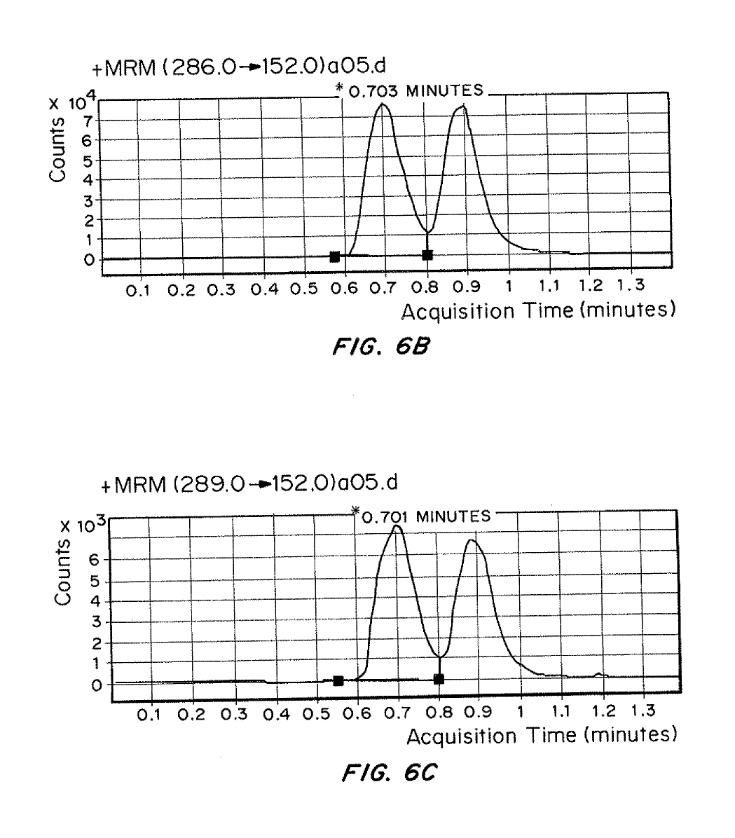

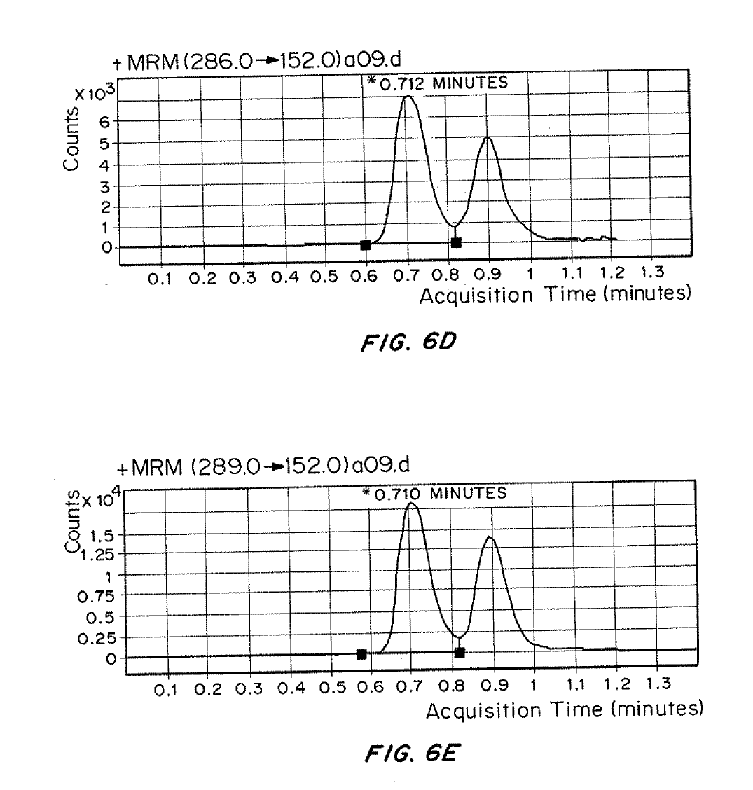

The calibration curve is shown in FIG. 6A. The chromatograms are shown in FIGS. 6B-E.

TABLE 7
Data table for nordiazepam

| | | Nordiazepam | Nordiazepam Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 4.714 | 0.5716 | 32.9 |
| control | | | | | |
| Calibrator | Cal | 20.0000 | 4.754 | 17.3339 | 67.3 |
| 1 | | | | | |
| Calibrator | Cal | 200.0000 | 4.738 | 192.5931 | 62.3 |
| 2 | | | | | |
| Calibrator | Cal | 500.0000 | 4.738 | 482.9339 | 63.1 |
| 3 | | | | | |
| Calibrator | Cal | 1000.0000 | 4.738 | 1010.0677 | 61.1 |
| 4 | | | | | |
| Calibrator | Sample | | 4.877 | 2.1059 | 69.6 |
| 1:10 | | | | | |
| PM 100 | Sample | | 4.958 | 0.0824 | 63.7 |
| BioRad | Sample | | 4.746 | 373.2174 | 61.5 |
| C3 | | | | | |
| Benz | Sample | | 4.746 | 94.4419 | 62.7 |
| Positive | Sample | | 4.746 | 334.2552 | 60.3 |
| Control | | | | | |

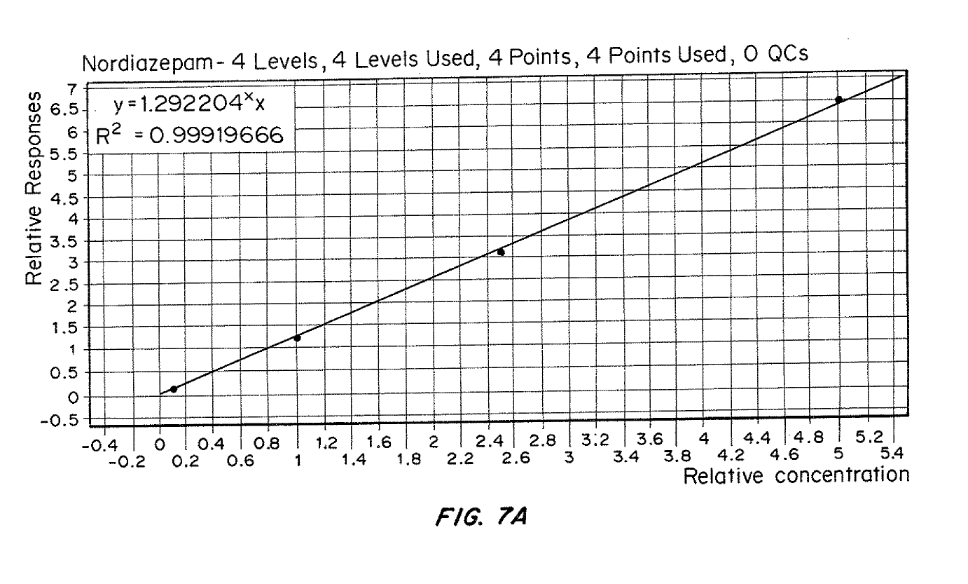

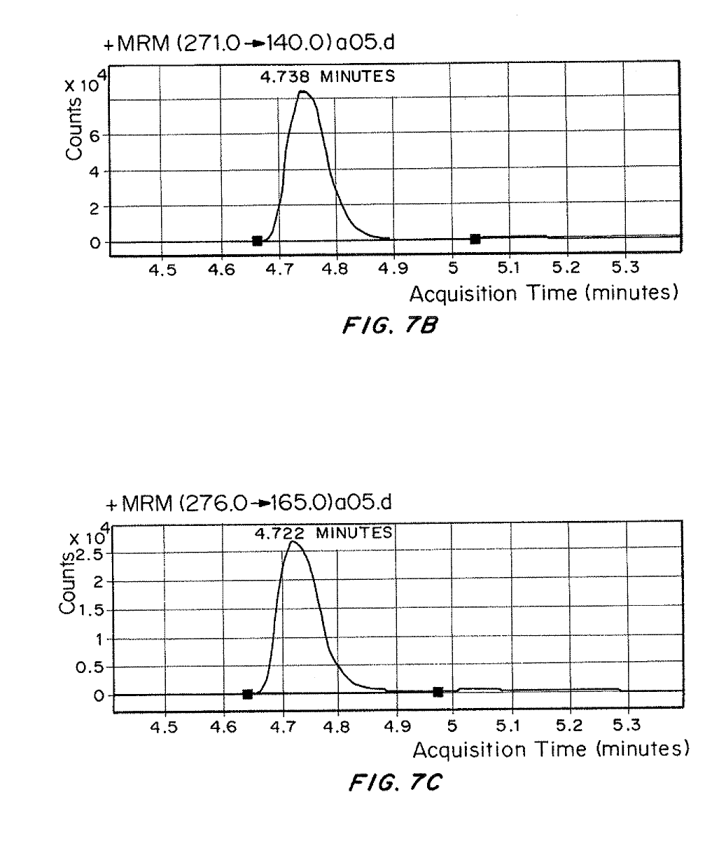

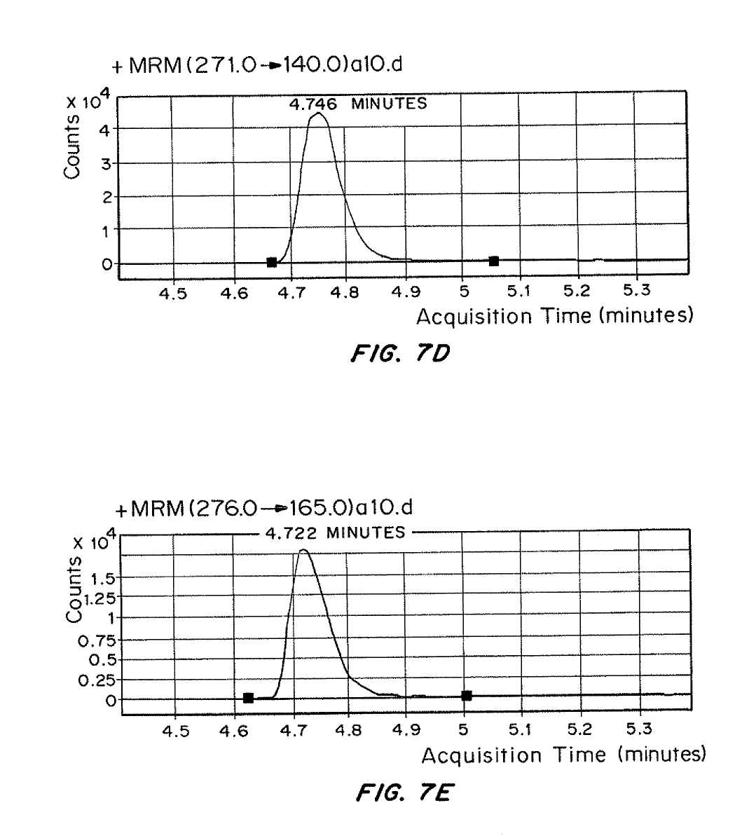

The calibration curve is shown in FIG. 7A. The chromatograms are shown in FIGS. 7B-E.

TABLE 8
Data table for alpha-OH-alprazolam

| | | Nordiazepam | Nordiazepam Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 4.235 | 0.0691 | 105.0 |
| control | | | | | |
| Calibrator | Cal | 20.0000 | 4.316 | 17.7111 | 34.8 |
| 1 | | | | | |
| Calibrator | Cal | 200.0000 | 4.324 | 192.2308 | 34.1 |
| 2 | | | | | |
| Calibrator | Cal | 500.0000 | 4.324 | 504.8577 | 34.8 |
| 3 | | | | | |
| Calibrator | Cal | 1000.0000 | 4.324 | 999.1707 | 35.8 |
| 4 | | | | | |
| Calibrator | Sample | | 4.340 | 1.6273 | 26.5 |
| 1:10 | | | | | |
| PM 100 | Sample | | 4.340 | 0.1340 | 29.4 |
| BioRad | Sample | | 4.324 | 379.2510 | 33.6 |
| C3 | | | | | |
| Benz | Sample | | 4.332 | 100.2756 | 33.8 |
| Positive | Sample | | 4.324 | 163.3614 | 33.8 |
| Control | | | | | |

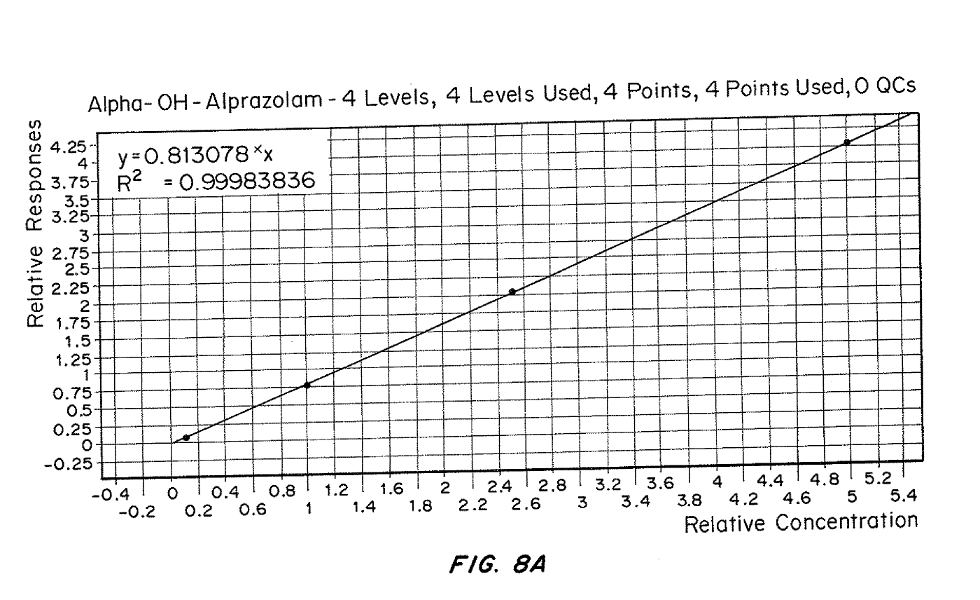

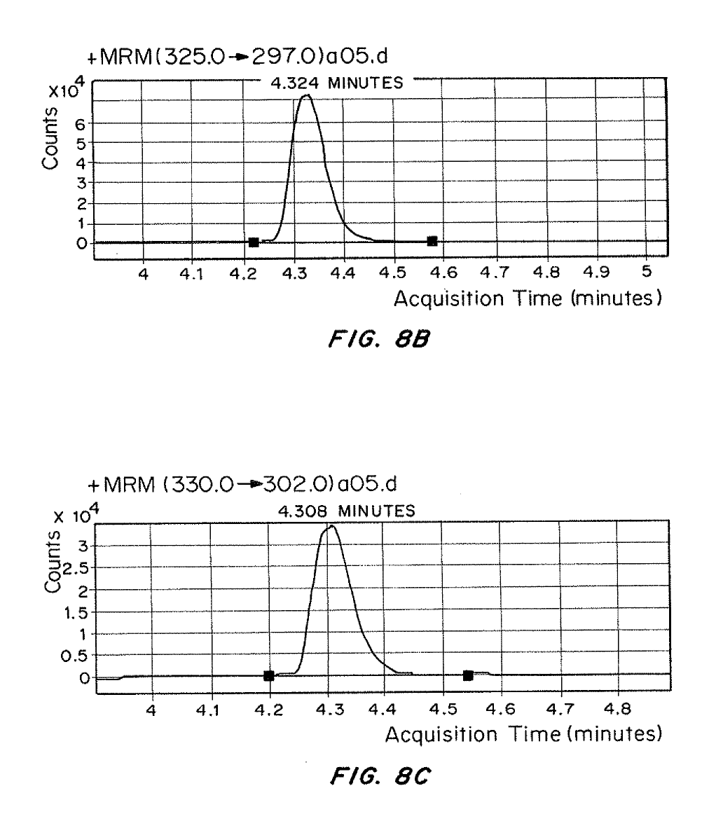

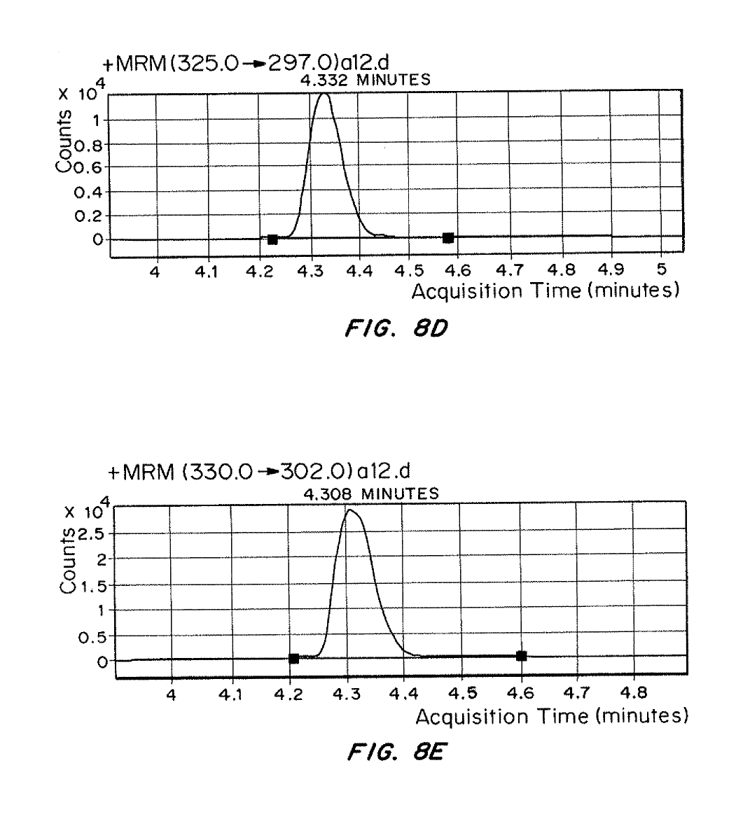

The calibration curve is shown in FIG. 8A. The chromatograms are shown in FIGS. 8B-E.

TABLE 9
Data table for carisoprodol

| | | Nordiazepam | Nordiazepam Results | | |
|---|---|---|---|---|---|
| | | Experimental | | Calculated | |
| Sample | | Concen- | Retention | Concen- | Qualifier |
| Name | Type | tration | Time | tration | Ratio |
| Neg. | Sample | | 4.733 | 0.2899 | 45.5 |
| control | | | | | |
| Calibrator | Cal | 100.0000 | 4.428 | 99.6750 | 79.1 |
| 1 | | | | | |
| Calibrator | Cal | 1000.0000 | 4.428 | 1043.7631 | 77.6 |
| 2 | | | | | |
| Calibrator | Cal | 2500.0000 | 4.428 | 2555.6678 | 76.5 |
| 3 | | | | | |
| Calibrator | Cal | 5000.0000 | 4.428 | 4963.4200 | 77.8 |
| 4 | | | | | |
| Calibrator | Sample | | 4.428 | 10.3865 | 68.0 |
| 1:10 | | | | | |
| PM 100 | Sample | | 4.420 | 0.1858 | 40.5 |
| BioRad | Sample | | 4.436 | 0.3650 | 39.3 |
| C3 | | | | | |
| Benz | Sample | | — | — | — |
| Positive | Sample | | 4.436 | 1377.1566 | 76.5 |
| Control | | | | | |

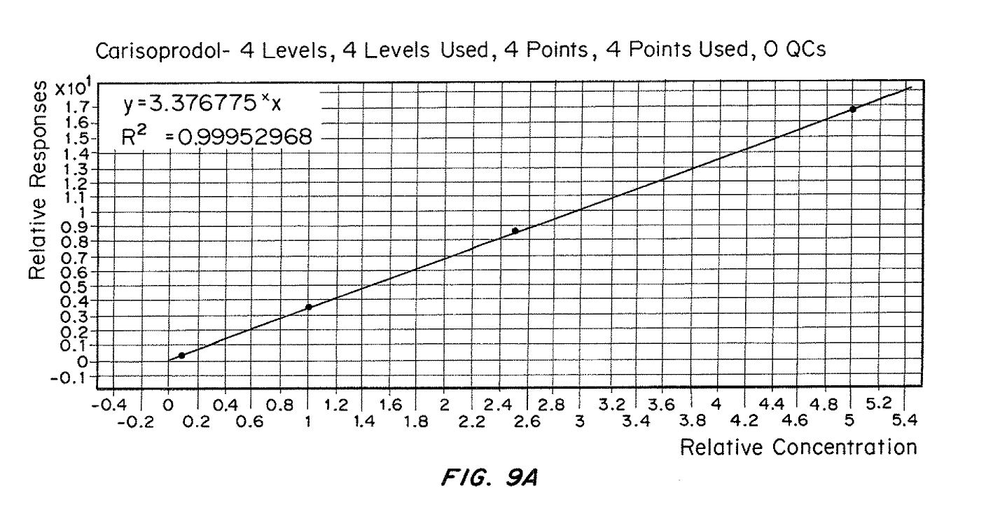

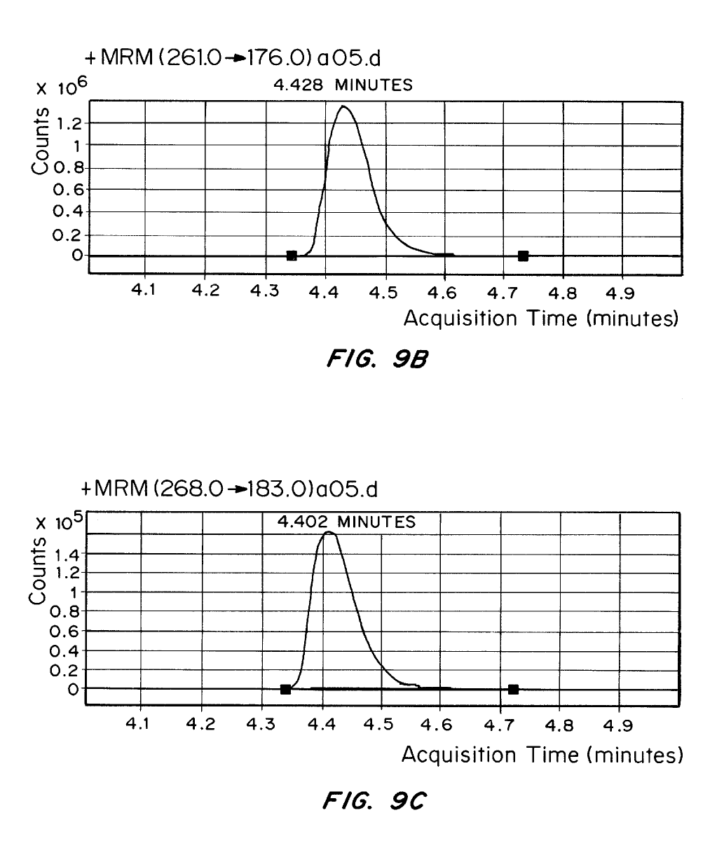

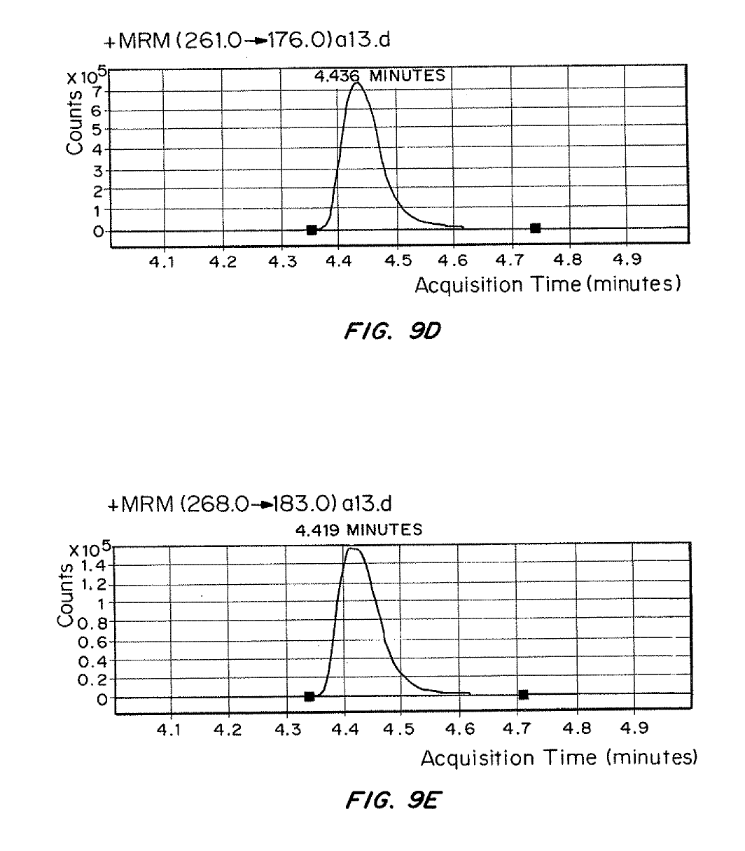

The calibration curve is shown in FIG. 9A. The chromatograms are shown in FIGS. 9B-E.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

We claim:

1. A method for simultaneously detecting the presence of two or more substances in a biological sample from an animal, the method comprising:
(a) extracting the biological sample using solid phase extraction to produce an eluate; and
(b) analyzing the eluate for the two or more substances simultaneously using liquid chromatography/mass spectrometry (LC/MS).

2. The method of claim 1, wherein the biological sample is a urine sample, oral fluid sample, blood sample, tissue sample and ocular fluid.

3. The method of claim 1, wherein the two or more substances are prescription drugs and metabolites thereof, illicit drugs and metabolites thereof, and combinations thereof.

4. The method of claim 3, wherein the substances are illicit drugs or used to treat pain.

5. The method of claim 1, wherein the biological sample is enzymatically hydrolyzed prior to step (a).

6. The method of claim 1, wherein the extraction is done in multi-well plate.

7. The method of claim 6, wherein step (a) is automated.

8. The method of claim 1, wherein the solid phase extraction is done at neutral pH.

9. The method of claim 1, wherein the mass spectrometer is a triple quadrupole mass spectrometer.

10. The method of claim 9, wherein the collision gas in the mass spectrometer is nitrogen.

11. The method of claim 1, wherein the liquid chromatography uses a solvent gradient.

12. The method of claim 1, wherein the method takes from about 11 minutes to about 15 minutes.

13. The method of claim 12, wherein the method takes less than about 11 minutes.

14. The method of claim 12, wherein the method takes less than about 9 minutes.

15. The method of claim 12, wherein the method takes about 8 minutes.

16. The method of claim 12, wherein the method takes less than about 8 minutes.

17. The method of claim 1, wherein the method can analyze from about 4 to about 8 different drug classes.

18. The method for claim 17, wherein the method can simultaneously detect the presence of 30 substances.

19. The method for claim 18, wherein the method can simultaneously detect the presence of 48 substances.

20. The method of claim 1, wherein the animal is a mammal.

21. The method of claim 20, wherein the mammal is a human.
